(19) United States
(12) Patent Application Publication
(10) Pub. No.: US 2023/0219231 A1
(43) Pub. Date: Jul. 13, 2023

(54) CONTROL APPARATUS FOR CONTROLLING ROBOT ARM APPARATUS THAT HOLDS HOLDABLE OBJECT

(71) Applicant: Panasonic Intellectual Property Management Co., Ltd., Osaka (JP)

(72) Inventors: Tsukasa OKADA, Osaka (JP); Tomohide ISHIGAMI, Osaka (JP); Yuzuka ISOBE, Osaka (JP); Kozo EZAWA, Osaka (JP); Yoshinari MATSUYAMA, Osaka (JP); Kenji TOKUDA, Ishikawa (JP)

(21) Appl. No.: 18/121,155

(22) Filed: Mar. 14, 2023

Related U.S. Application Data
(63) Continuation of application No. PCT/JP2021/032999, filed on Sep. 8, 2021.

(30) Foreign Application Priority Data
Oct. 8, 2020 (JP) 2020-170713

(51) Int. Cl. B25J 9/16; B25J 13/08; B25J 19/02; G06T 7/73

(52) U.S. Cl. CPC B25J 9/1697; B25J 13/089; B25J 19/023; G06T 7/73; G06T 2207/10028; G06T 2207/30204

(57) ABSTRACT

A target object setting unit sets a position of a target object in a work object. A feature point recognizer detects feature points of a work object from a captured image obtained by an image capturing apparatus, the image including the work object and a holdable object. A first position calculator calculates a position of the target object in a coordinate system of the image capturing apparatus based on the feature points. A second position calculator calculates a position of the holdable object in the coordinate system of the image capturing apparatus based on the captured image. A control signal generator converts the positions of the target object and the holdable object in the coordinate system of the image capturing apparatus, into positions in a coordinate system of the robot arm apparatus, and outputs a first control signal to the robot arm apparatus based on the converted positions of the target object and the holdable object, for moving the holdable object to the position of the target object.

This is a continuation application of International Application No. PCT/JP2021/032999, with an international filing date of Sep. 8, 2021, which claims priority of Japanese Patent Application No. 2020-170713 filed on Oct. 8, 2020, the content of which is incorporated herein by reference.

### BACKGROUND

### 1. Technical Field

The present disclosure relates to a control apparatus and a control method for a robot arm apparatus, and relates to a robot arm system.

### 2. Description of Related Art

In order to solve the shortage of workers due to the low birth rate and the population aging, and reduce the employees’ fees, robot arm apparatuses or robot hand apparatuses are used to automate works of various fields, which have been conventionally performed by humans.

For example, International Publication WO 2018/150489 A1 discloses an operation method of a surgical instrument in which the surgical instrument is remotely operated through an input device, the surgical instrument being connected to a robot arm with a position detector at each joint thereof. In addition, Japanese Patent Laid-open Publication JP 2015-136764 A discloses a control apparatus of a robot with an end effector for moving a work object.

### SUMMARY

In general, the robot arm apparatus controls position and movement of its arm and hand, with reference to a coordinate system based on position and posture of a non-movable part of the apparatus, such as main body or base (hereinafter, referred to as “coordinate system of the robot arm apparatus” or “robot coordinate system”).

However, a work object to be worked by the robot arm apparatus does not have a known position in the robot coordinate system. In addition, the position of a work object may vary during work. When the position of the work object is unknown, it is not possible to accurately perform the work on the work object using the robot arm apparatus. Therefore, even when the work object does not have a known fixed position in the robot coordinate system, it is necessary to accurately perform the work on the work object using the robot arm apparatus.

One non-limiting and exemplary embodiment provides a control apparatus and a control method for a robot arm apparatus, the control apparatus and control method being able to control the robot arm apparatus to accurately perform work on a work object, even when the work object does not have a fixed known position in the robot coordinate system. In addition, another non-limiting and exemplary embodiment provides a robot arm system including the control apparatus and the robot arm apparatus as described above.

According to one aspect of the present disclosure, a control apparatus for controlling a robot arm apparatus that holds a holdable object is provided. The control apparatus comprising: a camera that captures an image including at least a part of a work object and a tip of the holdable object; and a processing circuit that controls the robot arm apparatus that holds the holdable object. The processing circuit sets a position of a target object included in the work object. The processing circuit detects feature points of the work object from the captured image. The processing circuit calculates a position of the target object based on the feature points of the work object. The processing circuit calculates a position of the tip of the holdable object based on the captured image. The processing circuit outputs a first control signal to the robot arm apparatus based on the position of the target object and the position of the tip of the holdable object, the first control signal causing the tip of the holdable object to move to the position of the target object.

These general and specific aspects may be implemented by a system, a method, a computer program, and any combination of the system, the method, and the computer program.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

According to one aspect of the present disclosure, even when the work object does not have a known fixed position in the robot coordinate system, it is possible to control the robot arm apparatus to accurately perform the work on the work object.

### BRIEF DESCRIPTION OF DRAWINGS

FIG. 1 is a schematic view showing a configuration of a robot arm system according to a first embodiment.

FIG. 2 is a partially enlarged view of a power driver 5 and a marker 6 of FIG. 1.

FIG. 3 is a perspective view showing a circuit board 8 of FIG. 1.

FIG. 4 is a diagram showing feature points F included in the circuit board 8 of FIG. 3.

FIG. 5 is a block diagram showing a configuration of a control apparatus 1 of FIG. 1.

FIG. 6 is a view showing an exemplary captured image 70 obtained by an image capturing apparatus 7 of FIG. 1.

FIG. 7 is a diagram for explaining map points and keyframes of a feature point map stored in a storage device 15 of FIG. 5.

FIG. 8 is a diagram showing an exemplary feature point map stored in the storage device 15 of FIG. 5.

FIG. 9 is a flowchart showing a robot arm control process executed by the control apparatus 1 of FIG. 1.

FIG. 10 is a flowchart showing a subroutine of step S4 (position calculation process of target object) of FIG. 9.

FIG. 11 is diagrams for explaining feature point association executed in step S13 of FIG. 10, where (a) shows a captured image 70A obtained by the image capturing apparatus 7, and (b) shows a similar image 70B read from the storage device 15.

FIG. 12 is a diagram showing calculation of a position of a target object in a camera coordinate system, executed in step S15 of FIG. 10.

FIG. 13 is a flowchart showing a subroutine of step S6 (position calculation process of holdable object) of FIG. 9.

FIG. 14 is a diagram for explaining calculation of a position of a tip of a holdable object in the camera coordinate system, executed in step S24 of FIG. 13.

FIG. 15 is a diagram showing an exemplary image 30 displayed on a display apparatus 3 of FIG. 1.

FIG. 16 is a schematic view showing a configuration of a robot arm system according to a second embodiment.

FIG. 17 is a block diagram showing a configuration of a control apparatus 1A of FIG. 16.

FIG. 18 is a flowchart showing a robot arm control process executed by the control apparatus 1A of FIG. 16.

FIG. 19 is a flowchart showing a subroutine of step S4A (position calculation process of target object) of FIG. 18.

FIG. 20 is a diagram for explaining recognition of a target object using image processing, executed in step S35 of FIG. 19.

FIG. 21 is a diagram for explaining recognition of the target object based on user inputs, executed in step S35 of FIG. 19, the diagram showing an exemplary image 30A displayed on a display apparatus 3 of FIG. 16.

FIG. 22 is a schematic view showing a configuration of a robot arm system according to a third embodiment.

FIG. 23 is a block diagram showing a configuration of a control apparatus 1B of FIG. 22.

FIG. 24 is a flowchart showing a robot arm control process executed by the control apparatus 1B of FIG. 22.

FIG. 25 is a flowchart showing a subroutine of step S4B (position calculation process) of FIG. 24.

FIG. 26 is a diagram showing an exemplary image 30B displayed on a display apparatus 3 of FIG. 22.

FIG. 27 is a schematic view showing a configuration of a robot arm system according to a fourth embodiment.

FIG. 28 is a plan view showing a circuit board 8C of FIG. 27.

FIG. 29 is a block diagram showing a configuration of a control apparatus 1C of FIG. 27.

FIG. 30 is a flowchart showing a position calculation process executed by a position calculator 12C of FIG. 29.

FIG. 31 is a diagram for explaining calibration of a scale of a feature point map according to a comparison example.

FIG. 32 is a flowchart showing a subroutine of step S52 (scale calibration process) of FIG. 30.

FIG. 33 is a diagram for explaining association of feature points, executed in step S63 of FIG. 32.

FIG. 34 is a diagram for explaining calibration of a scale of a feature point map, executed in step S67 of FIG. 32.

FIG. 35 is a schematic view showing a configuration of a robot arm system according to a fifth embodiment, with a holdable object being at a first position.

FIG. 36 is a schematic view showing a configuration of the robot arm system according to the fifth embodiment, with the holdable object being at a second position.

FIG. 37 is a schematic view showing a configuration of a robot arm system according to a sixth embodiment.

FIG. 38 is a block diagram showing a configuration of a control apparatus 1E of FIG. 37.

FIG. 39 is an enlarged view showing a tip of an arm 4b of FIG. 37.

FIG. 40 is a flowchart showing a robot arm control process executed by the control apparatus 1E of FIG. 37.

FIG. 41 is a block diagram showing a configuration of a control apparatus IF of a robot arm system according to a seventh embodiment.

FIG. 42 is a diagram showing an exemplary image 30C displayed on a display apparatus 3 of the robot arm system according to the seventh embodiment.

FIG. 43 is a diagram showing details of a window 35 of FIG. 42, including radar charts 36 and 37 in which a tip of a holdable object is at a first distance from a target object.

FIG. 44 is a diagram showing details of the window 35 of FIG. 42, including the radar charts 36 and 37 in which the tip of the holdable object is at a second distance shorter than the first distance from the target object.

FIG. 45 is a diagram showing an alternative window 35A displayed on the display apparatus 3 of the robot arm system according to the seventh embodiment.

FIG. 46 is a schematic view showing a configuration of a robot arm system according to a first modified embodiment of the seventh embodiment.

FIG. 47 is a diagram showing an exemplary image 30D displayed on a touch panel apparatus 3F of the robot arm system of FIG. 46.

FIG. 48 is a block diagram showing a configuration of a control apparatus 1G of a robot arm system according to a second modified embodiment of the seventh embodiment.

### DETAILED DESCRIPTION

Hereinafter, embodiments according to the present disclosure are described with reference to the drawings. In each of the following embodiments, the same reference numerals are given to similar components.

### First Embodiment

Hereinafter, a robot arm system according to a first embodiment is described.

As described above, a work object to be worked by a robot arm apparatus does not have a known position in the robot coordinate system. In addition, when the robot arm apparatus holds some holdable object for a work on the work object, the holdable object also does not have a known position in the robot coordinate system. Further, the positions of the work object and the holdable object may vary during work. For example, consider a case in which the robot arm apparatus holds a power driver as the holdable object, and using the power driver, inserts a screw into a screw hole of a circuit board as the work object, thus automatically fastening the circuit board to other components. In this case, the circuit board is not necessarily fixed to a workbench. In addition, the position of the power driver held by the robot arm apparatus varies each time the power driver is held. Therefore, the power driver and the circuit board do not have known fixed positions in the robot coordinate system.

When the position of the holdable object or the work object is unknown, it is not possible to accurately perform the work on the work object using the holdable object held by the robot arm apparatus. Therefore, even when at least one of the holdable object and the work object does not have a known fixed position in the robot coordinate system, it is required to accurately perform the work on the work object using the holdable object held by the robot arm apparatus.

In the first embodiment, we will describe the robot arm system capable of controlling the robot arm apparatus to accurately perform the work on the work object using the holdable object, even when at least one of the holdable object and the work object does not have a known fixed position in the robot coordinate system.

### Configuration of First Embodiment Overall Configuration

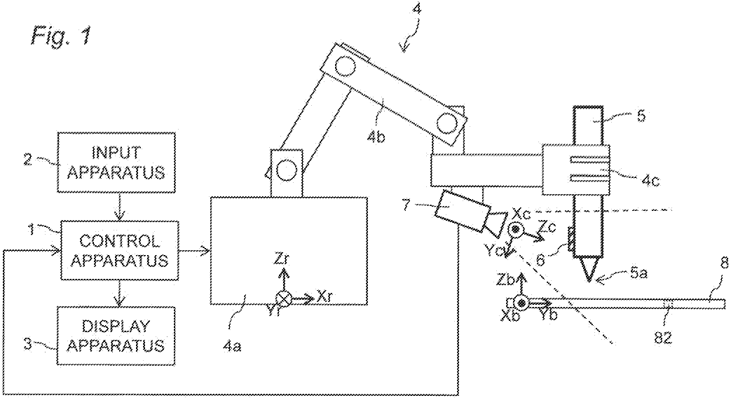

FIG. 1 is a schematic view showing a configuration of a robot arm system according to a first embodiment. The robot arm system of FIG. 1 is provided with: a control apparatus 1, an input apparatus 2, a display apparatus 3, a robot arm apparatus 4, a power driver 5, a marker 6, an image capturing apparatus 7, and a circuit board 8.

The robot arm apparatus 4 moves a holdable object held by the robot arm apparatus 4, to a position of at least one target object in a work object, under the control of the control apparatus 1. In the example of FIG. 1, the power driver 5 is the holdable object held by the robot arm apparatus 4, and the circuit board 8 is the work object to be worked by the robot arm apparatus 4 using the power driver 5. When at least one screw hole 82 in the circuit board 8 is set as the target object, the robot arm apparatus 4 moves the tip of the power driver 5 to the position of the screw hole 82, and inserts a screw into the screw hole 82 using the power driver 5 to fasten the circuit board 8 to other components.

The control apparatus 1 controls the robot arm apparatus 4 holding the power driver 5, based on a captured image obtained by the image capturing apparatus 7, and/or based on user inputs inputted through the input apparatus 2. The control apparatus 1 is, for example, a general-purpose personal computer or a dedicated apparatus.

The input apparatus 2 includes a keyboard and a pointing apparatus, and obtains the user inputs for controlling the robot arm apparatus 4.

The display apparatus 3 displays the captured image obtained by the image capturing apparatus 7, the status of the robot arm apparatus 4, information related to the control of the robot arm apparatus 4, and others.

The input apparatus 2 may be configured as a touch panel integrated with the display apparatus 3.

The robot arm apparatus 4 is provided with: a main body 4a, an arm 4b, and a hand 4c. The main body 4a is fixed to a floor (or a wall, a ceiling, or the like). The hand 4c is coupled to the main body 4a via the arm 4b. In addition, the hand 4c holds an arbitrary item, e.g., the power driver 5 in the example of FIG. 1. The arm 4b is provided with a plurality of links and a plurality of joints, and the links are rotatably coupled to each other via the joints. With such a configuration, the robot arm apparatus 4 can move the power driver 5 within a predetermined range around the main body 4a.

As described above, the power driver 5 is held by the hand 4c of the robot arm apparatus 4.

The marker 6 is fixed at a known position of the power driver 5. The marker 6 is fixed to the power driver 5 such that the image capturing apparatus 7 can capture the marker 6 when the robot arm apparatus 4 holds the power driver 5. The marker 6 has a pattern formed such that the direction and the distance of the marker 6 as seen from the image capturing apparatus 7 can be calculated, in a manner similar to that of, for example, a marker used in the field of augmented reality (also referred to as “AR marker”).

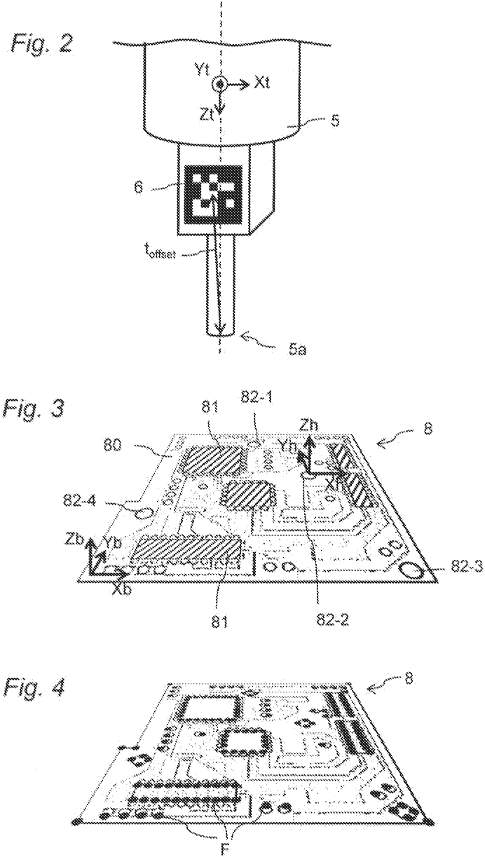

FIG. 2 is a partially enlarged view of the power driver 5 and the marker 6 of FIG. 1. As described above, the marker 6 has a pattern formed such that the direction and the distance of the marker 6 as seen from the image capturing apparatus 7 can be calculated. A tip 5a of the power driver 5 has a known offset with respect to a predetermined position (for example, the center) of the marker 6. This offset is represented by a vector t_{offset}. Therefore, the relative position (i.e., the direction and the distance) of the tip 5a of the power driver 5 with respect to the marker 6 is known, and therefore, if the position of the marker 6 is known, then it is possible to calculate the position (i.e., the direction and the distance) of the tip 5a of the power driver 5. The power driver 5 contacts with the circuit board 8 at the tip 5a thereof.

The image capturing apparatus 7 obtains a captured image including the tip 5a of the power driver 5, and at least a part of the circuit board 8. The image capturing apparatus 7 may be a monocular camera or the like, without function of detecting distances from the image capturing apparatus 7 to points captured by the image capturing apparatus 7. Further, the image capturing apparatus 7 may be a stereo camera, an RGB-D camera, or the like, capable of detecting distances from the image capturing apparatus 7 to points captured by the image capturing apparatus 7. The image capturing apparatus 7 may capture still images at predetermined time intervals, or may extract frames at predetermined time intervals from a series of frames of a video. The image capturing apparatus 7 gives, to each image, a time stamp of the time when the image is captured.

The image capturing apparatus 7 may be fixed to the robot arm apparatus 4 such that when the robot arm apparatus 4 holds the power driver 5, a relative position of the image capturing apparatus 7 with respect to the power driver 5 is fixed, and the image capturing apparatus 7 can capture the tip 5a of the power driver 5. In this case, the image capturing apparatus 7 is fixed to the same link as that to which the hand 4c is connected, among the plurality of links of the arm 4b. As a result, there is no movable part, such as the joint of the arm 4b, between the image capturing apparatus 7 and the hand 4c, and therefore, the relative position of the image capturing apparatus 7 with respect to the power driver 5 is fixed when the robot arm apparatus 4 holds the power driver 5. Further, if the image capturing apparatus 7 can capture the tip 5a of the power driver 5 and the marker 6 when the robot arm apparatus 4 holds the power driver 5, the image capturing apparatus 7 may be fixed to the robot arm apparatus 4 such that the relative position of the image capturing apparatus 7 with respect to the power driver 5 may vary.

FIG. 3 is a perspective view showing the circuit board 8 of FIG. 1. The circuit board 8 is provided with a printed wiring board 80, a plurality of circuit elements 81, and a plurality of screw holes 82-1 to 82-4 (also collectively referred to as the “screw hole 82”). In each embodiment of the present disclosure, at least one of the screw holes 82-1 to 82-4 is set as the target object.

FIG. 4 is a diagram showing feature points F included in the circuit board 8 of FIG. 3. The feature points F are points whose luminance or color can be distinguished from that of surrounding pixels, and whose positions can be accurately determined. The feature points F are detected from, for example, vertices or edges of structures, such as the printed wiring board 80, the circuit elements 81, and the screw holes 82.

The circuit board 8 is disposed on a workbench, a belt conveyor, or the like (not shown).

In order to describe the operation of the robot arm system of FIG. 1, reference is made to a plurality of coordinate systems, that is, a coordinate system of the robot arm apparatus 4, a coordinate system of the image capturing apparatus 7, a coordinate system of the power driver 5, a coordinate system of the circuit board 8, and a coordinate system of the screw hole 82.

As shown in FIG. 1, the robot arm apparatus 4 has a three-dimensional coordinate system based on the position or posture of a non-movable part of the apparatus, such as the main body 4a or a base (“coordinate system of robot arm apparatus” or “robot coordinate system”). The robot coordinate system has coordinate axes Xr, Yr, and Zr. For example, the origin of the robot coordinate system is provided at the center of the bottom surface of the main body 4a of the robot arm apparatus 4, and the direction of the robot coordinate system is set such that two of the coordinate axes are parallel to the floor, and the remaining one coordinate axis is perpendicular to the floor.

In addition, as shown in FIG. 1, the image capturing apparatus 7 has a three-dimensional coordinate system based on the position and the posture of the image capturing apparatus 7 {hereinafter referred to as “coordinate system of image capturing apparatus” or “camera coordinate system”). The camera coordinate system has coordinate axes Xc, Yc, and Zc. For example, the origin of the camera coordinate system is provided on the optical axis of the image capturing apparatus 7, and the direction of the camera coordinate system is set such that one of the coordinate axes coincides with the optical axis, and the remaining two coordinate axes are perpendicular to the optical axis. The position in the camera coordinate system indicates a position as seen from the image capturing apparatus 7.

Furthermore, as shown in FIG. 2, the power driver 5 has a three-dimensional coordinate system based on the position and the posture of the power driver 5 {hereinafter referred to as “holdable object coordinate system”). The holdable object coordinate system has coordinate axes Xt, Yt, and Zt. For example, the origin of the holdable object coordinate system is provided at the center of the power driver 5, and the direction of the holdable object coordinate system is set such that one of the coordinate axes coincides with the rotation axis of the tip 5a of the power driver 5, and the remaining two coordinate axes are perpendicular to the rotation axis. Further, the origin of the holdable object coordinate system may be provided at the tip 5a of the power driver 5.

In addition, as shown in FIGS. 1 and 3, the circuit board 8 has a three-dimensional coordinate system based on the position and the posture of the circuit board 8 {hereinafter referred to as “work object coordinate system”). The work object coordinate system has coordinate axes Xb, Yb, and Zb. For example, the origin of the work object coordinate system is provided on the optical axis of the image capturing apparatus 7 associated with a keyframe firstly obtained when generating a feature point map of the circuit board 8 described later, and the direction of the work object coordinate system is set such that one of the coordinate axes coincides with the optical axis of the image capturing apparatus 7 associated with the same keyframe, and the remaining two coordinate axes are perpendicular to the optical axis. The direction of the work object coordinate system may be set based on the design data of the circuit board 8, and for example, the coordinate axes may be set to be parallel or perpendicular to sides of the circuit board 8.

In addition, as shown in FIG. 3, each screw hole 82 set as a target object has a three-dimensional coordinate system based on the position and the direction of the screw hole 82 {hereinafter referred to as a “target object coordinate system”). FIG. 3 shows a case where the screw hole 82-2 is set as the target object. The target object coordinate system has coordinate axes Xh, Yh, and Zh. For example, the origin of the target object coordinate system is provided at the center of the screw hole 82-2, and the direction of the target object coordinate system is set such that two of the coordinate axes are parallel to the surface of the circuit board 8, and the remaining one coordinate axis is set perpendicular to the surface of the circuit board 8.

The positions of the origins and the directions of the coordinate axes of the robot coordinate system, the camera coordinate system, the holdable object coordinate system, the work object coordinate system, and the target object coordinate system shown in FIGS. 1 to 3 are merely examples, and these coordinate systems may have different positions of the origin and/or different directions of the coordinate axes.

Since the position of the power driver 5 in the camera coordinate system varies each time the robot arm apparatus 4 holds the power driver 5, the power driver 5 does not have a known position in the camera coordinate system.

### Configuration of Control Apparatus

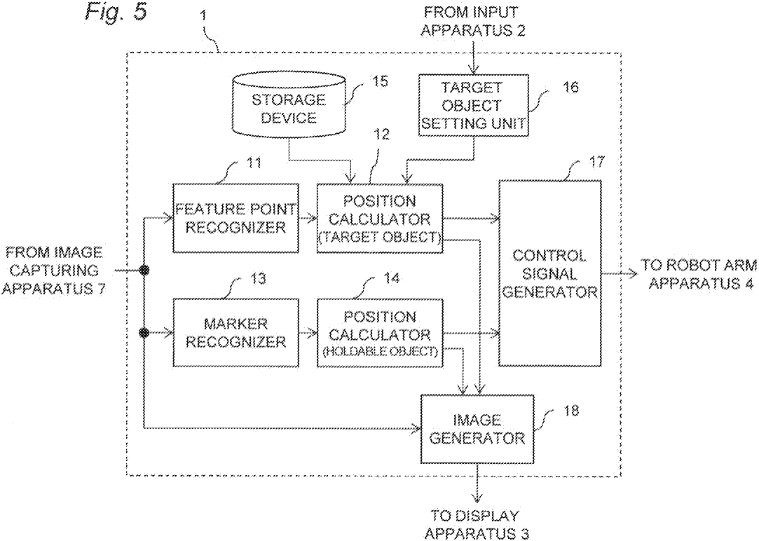

FIG. 5 is a block diagram showing a configuration of the control apparatus 1 of FIG. 1. The control apparatus 1 is provided with: a feature point recognizer 11, a position calculator 12, a marker recognizer 13, a position calculator 14, a storage device 15, a target object setting unit 16, a control signal generator 17, and an image generator 18.

The control apparatus 1 obtains a captured image obtained by the image capturing apparatus 7, the captured image including the tip 5a of the power driver 5, and at least a part of the circuit board 8.

The feature point recognizer 11 detects feature points of the circuit board 8 from the captured image obtained by the image capturing apparatus 7, the captured image including the at least part of the circuit board 8 and the tip 5a of the power driver 5. In addition, the feature point recognizer 11 extracts corresponding feature values using, for example, Scale Invariant Feature Transform (SIFT) or Oriented FAST and Rotated BRIEF (ORB).

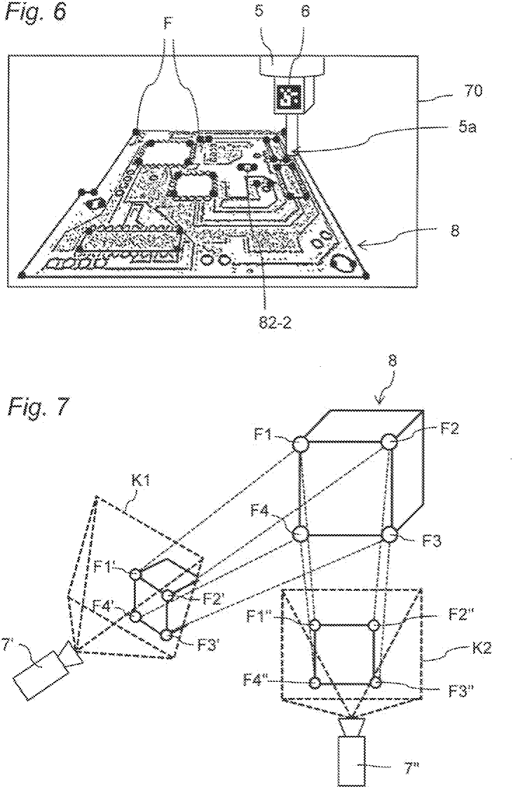

FIG. 6 is a view showing an exemplary captured image 70 obtained by the image capturing apparatus 7 of FIG. 1. In the example of FIG. 6, the captured image 70 includes the circuit board 8 and the tip 5a of the power driver 5. For purpose of explanation, FIG. 6 further shows feature points F of the circuit board 8 detected by the feature point recognizer 11.

The storage device 15 stores a feature point map in advance, the feature point map including map points and keyframes related to a plurality of feature points included in the circuit board 8. The map points include positions (three-dimensional coordinates) of the feature point of the circuit board 8 in the work object coordinate system, feature values of the feature points, and identifiers of the feature points. The map points are generated based on a plurality of captured images obtained by capturing the circuit board 8 from a plurality of different positions. The keyframes indicate the status of the image capturing apparatus 7 and the captured images, occurring when capturing the circuit board 8 from the plurality of different positions in order to generate the map points. That is, the keyframes include the positions (three-dimensional coordinates) and the postures of the image capturing apparatus 7 in the work object coordinate system, the positions (two-dimensional coordinates) and the feature values of the feature points in the captured images, and identifiers of the map points corresponding to the feature points in the captured images.

FIG. 7 is a diagram for explaining the map points and the keyframes of the feature point map stored in the storage device 15 of FIG. 5. In the example of FIG. 7, the circuit board 8 having the feature points F1 to F4 is schematically shown. In this case, the map points include the positions of the feature points F1 to F4 of the circuit board 8 in the work object coordinate system, the feature values of the feature points, and the identifiers of the feature points. A keyframe K1 shows the status of the image capturing apparatus 7 (indicated as the image capturing apparatus 7′) and the captured image, occurring when capturing the circuit board 8 from a first position. The captured image of the image capturing apparatus 7′ includes feature points F1′ to F4′ corresponding to the feature points F1 to F4 of the circuit board 8, respectively. That is, the keyframe K1 includes the position and the posture of the image capturing apparatus 7′ in the work object coordinate system, the positions and the feature values of the feature points F1′ to F4′ in the captured image, and the identifiers of the map points corresponding to the feature points F1′ to F4′ in the captured image. In addition, a keyframe K2 shows the status of the image capturing apparatus 7 (indicated as the image capturing apparatus 7″) and the captured image, occurring when capturing the circuit board 8 from a second position. The captured image of the image capturing apparatus 7″ includes feature points F1″ to F4″ corresponding to the feature points F1 to F4 of the circuit board 8, respectively. That is, the keyframe K2 includes the position and the posture of the image capturing apparatus 7″ in the work object coordinate system, the positions and the feature values of the feature points F1″ to F4″ in the captured image, and the identifiers of the map points corresponding to the feature points F1″ to F4″ in the captured image.

The storage device 15 may store the captured images themselves captured in order to generate the map points, in association with the keyframse.

The feature point map is generated based on a plurality of captured images obtained by capturing the circuit board 8 from a plurality of different positions using, for example, Visual Simultaneous Localization and Mapping (Visual-SLAM). According to the Visual-SLAM, the positions of the map points are calculated as follows.

(1) The feature points of the circuit board 8 are detected from the captured image obtained by the image capturing apparatus 7 having a predetermined position and posture. A translation vector T1 and a rotation matrix R1, indicating the position and the posture of the image capturing apparatus 7 occurring when capturing the detected feature points, are calculated with reference to a point having known three-dimensional coordinates.

The image capturing apparatus 7 is moved, and the feature points of the circuit board 8 are detected from the captured image obtained by the image capturing apparatus 7 having a different position and a different posture. A translation vector T2 and a rotation matrix R2, indicating the position and the posture of the image capturing apparatus 7 occurring when capturing the detected feature points, are calculated with reference to the point having known three-dimensional coordinates.

The three-dimensional coordinates of the map points corresponding to the feature points included in both the captured images obtained before and after the movement of the image capturing apparatus 7 are calculated.

The image capturing apparatus 7 is moved, and the feature points of the circuit board 8 are detected from the captured image obtained by the image capturing apparatus 7 having a further different position and a further different posture. A translation vector T3 and a rotation matrix R3, indicating the position and the posture of the image capturing apparatus 7 occurring when capturing the detected feature points, are calculated with reference to the point having known three-dimensional coordinates. Thereafter, steps (3) to (4) are repeated.

The scale of the feature point map, that is, the distances among the feature points of the circuit board 8 in the work object coordinate system, may be calibrated based on, for example, design data of the circuit board 8. Further, when the feature point map is generated in advance, the scale of the feature point map may be calibrated by detecting the distances from the image capturing apparatus to points to be captured (see second and third embodiments). Furthermore, when the feature point map is generated in advance, the scale of the feature point map may be calibrated by detecting at least one marker fixed at a known position in the circuit board 8 (see a fourth embodiment).

In order to generate the feature point map, other image processing and positioning techniques may be used, such as structure from motion (SfM), instead of the Visual SLAM.

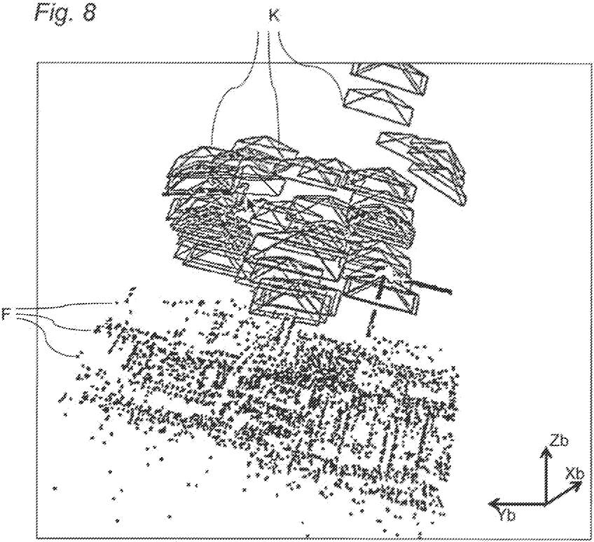

FIG. 8 is a diagram showing an exemplary feature point map stored in the storage device 15 of FIG. 5. FIG. 8 is a perspective view of a three-dimensional plot of the plurality of feature points F, and the positions and the postures of the image capturing apparatus 7 associated with the plurality of keyframes K. It is assumed that the image capturing apparatus 7 captures the circuit board 8 in various positions and postures during operation of the robot arm apparatus 4, and the feature point map includes a large number of keyframes K.

The target object setting unit 16 sets the position of at least one screw hole 82 in the circuit board 8, as the position of the target object. For example, the target object setting unit 16 sets a target object by selecting at least one of the plurality of map points stored in the storage device 15, based on user inputs obtained through the input apparatus 2. The target object setting unit 16 may store the target object having been set, in the storage device 15.

The position calculator 12 calculates the position and the direction of the screw hole 82 in the camera coordinate system, based on the feature points of the circuit board 8 detected by the feature point recognizer 11, and with reference to the feature point map read from the storage device 15. The direction of the screw hole 82 is represented by, for example, the direction of an axis passing through the screw hole 82 and perpendicular to the surface of the circuit board 8.

The marker recognizer 13 detects the marker 6 fixed at the known position in the power driver 5, from the captured image.

The position calculator 14 calculates the direction of the power driver 5 in the camera coordinate system based on the image of the marker 6 recognized by the marker recognizer 13, and calculates the position of the tip 5a of the power driver 5 in the camera coordinate system. The direction of the power driver 5 is represented by, for example, the direction of the rotation axis of the tip 5a of the power driver 5.

The control signal generator 17 converts the position and the direction of the screw hole 82 in the camera coordinate system calculated by the position calculator 12, into the position and the direction in the robot coordinate system. In addition, the control signal generator 17 converts the direction of the power driver 5 and the position of the tip 5a of the power driver 5 in the camera coordinate system calculated by the position calculator 14, into the position and the direction in the robot coordinate system. Since the robot arm apparatus 4 operates under the control of the control apparatus 1, and the image capturing apparatus 7 is fixed to the arm 4b of the robot arm apparatus 4, the image capturing apparatus 7 has the known position and the known posture in the robot coordinate system. Therefore, the control signal generator 17 can convert the coordinates of the screw hole 82 and the power driver 5 based on the position and the posture of the image capturing apparatus 7. In addition, the control signal generator 17 outputs a control signal to the robot arm apparatus 4 based on the converted position and direction of the screw hole 82, the converted direction of the power driver 5, and the converted position of the tip 5a of the power driver 5, the control signal causing the tip of the power driver 5 to move to the position of the screw hole 82. Thus, the control apparatus 1 automatically controls the robot arm apparatus 4.

The robot arm apparatus 4 moves the tip 5a of the power driver 5 to the screw hole 82 in accordance with the control signal from the control apparatus 1, such that the power driver 5 has a predetermined angle with respect to the screw hole 82. In this case, for example, the robot arm apparatus 4 moves the tip 5a of the power driver 5 to the screw hole 82 such that the direction of the power driver 5 coincides with the direction of the screw hole 82.

The image generator 18 outputs the captured image to the display apparatus 3. In addition, the image generator 18 may output the feature points of the circuit board 8, the position of the screw hole 82, and the position of the tip 5a of the power driver 5 to the display apparatus 3, such that the feature points of the circuit board 8, the position of the screw hole 82, and the position of the tip 5a of the power driver 5 overlap the captured image.

At least a part of the components 11 to 18 of the control apparatus 1 may be integrated with each other. The components 11 to 14 and 16 to 18 of the control apparatus 1 may be implemented as dedicated circuits, or may be implemented as programs executed by a general-purpose processor.

### Operation of First Embodiment

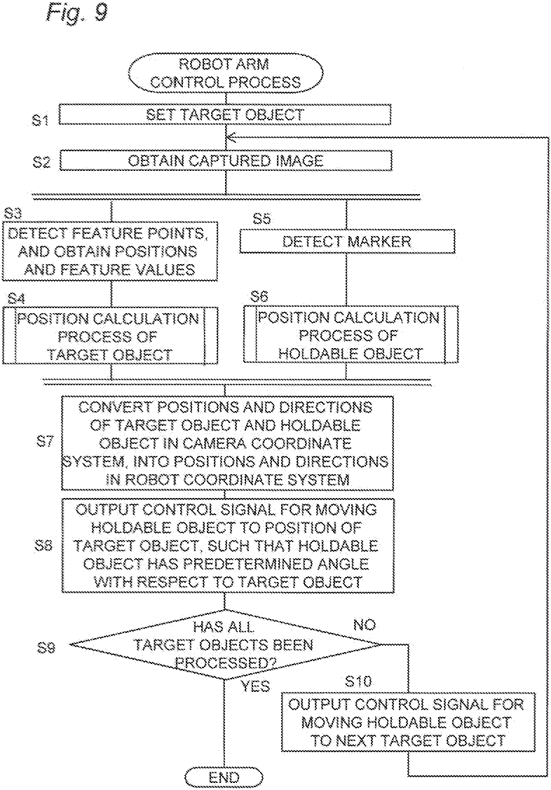

FIG. 9 is a flowchart showing a robot arm control process executed by the control apparatus 1 of FIG. 1.

The target object setting unit 16 sets at least one screw hole 82 in the circuit board 8, as the target object (step S1).

The control apparatus 1 obtains the captured image from the image capturing apparatus 7 (step S2).

The feature point recognizer 11 detects the feature points of the circuit board 8 from the captured image, and obtains positions and feature values of the feature points (step S3).

The position calculator 12 executes a position calculation process of target object to calculate the position and the direction of the screw hole 82 in the camera coordinate system (step S4).

The marker recognizer 13 detects the image of the marker 6 from the captured image (step S5).

The position calculator 14 executes a position calculation process of holdable object to calculate the direction of the power driver 5 and the position of the tip 5a of the power driver 5 in the camera coordinate system (step S6).

Steps S3 to S6 may be executed in parallel as shown in FIG. 9, or may be executed sequentially.

The control signal generator 17 converts the position and the direction of the screw hole 82, the direction of the power driver 5, and the position of the tip 5a of the power driver 5 in the camera coordinate system, into the positions and the directions thereof in the robot coordinate system (step S7).

The coordinate transformation from the position (xc, yc, zc) in the camera coordinate system to the position (xr, yr, zr) in the robot coordinate system is expressed as follows, for example, using a homogeneous coordinate transformation matrix.

$$\left(\begin{matrix}x r \\ y r \\ z r \\ 1\end{matrix}\right) = {\left(\begin{matrix}{R}_{c r} & {t}_{c r} \\ 0 & 1\end{matrix}\right)}^{- 1} \left(\begin{matrix}x c \\ y c \\ z c \\ 1\end{matrix}\right)$$

Here, R_{cr} denotes a matrix indicating the direction of the robot coordinate system with reference to on the direction of the camera coordinate system, and t_{cr} denotes a vector indicating the position of the origin of the robot coordinate system in the camera coordinate system. The matrix R_{cr} can be decomposed into matrices R_{α}, R_{β}, and R_{γ} representing rotation angles α, β, and γ around the X axis, the Y axis, and the Z axis, respectively.

$${R}_{c r} = {R}_{α} {R}_{β} {R}_{γ}$$

$${\text{R}}_{α} = \left(\begin{matrix}1 & 0 & 0 \\ 0 & cos α & - sin α \\ 0 & sin α & cos α\end{matrix}\right)$$

$${\text{R}}_{β} = \left(\begin{matrix}cos β & 0 & sin β \\ 0 & 1 & 0 \\ - sin β & 0 & cos β\end{matrix}\right)$$

$${\text{R}}_{γ} = \left(\begin{matrix}cos γ & - sin γ & 0 \\ sin γ & cos γ & 0 \\ 0 & 0 & 1\end{matrix}\right)$$

The matrix R_{cr} and the vector t_{cr} can be obtained from design data of the robot arm apparatus 4, and from a current status (that is, the content of the control signal).

The control signal generator 17 outputs a control signal causing the tip 5a of the power driver 5 to move to the position of the screw hole 82, such that the power driver 5 has a predetermined angle with respect to the screw hole 82 (for example, the direction of the power driver 5 coincides with the direction of the screw hole 82) (step S8).

The control apparatus 1 may repeat steps S2 to S8 while moving the tip 5a of the power driver 5 to the position of the screw hole 82.

When the plurality of screw holes 82 in the circuit board 8 are set as the target objects, the control signal generator 17 determines whether or not all the target objects have been processed (step S9): if YES, the process ends; if NO, the process proceeds to step S10.

The control signal generator 17 outputs a control signal causing the tip 5a of the power driver 5 to move to the next screw hole 82 (step S10). Thereafter, the control apparatus 1 repeats steps S2 to S10.

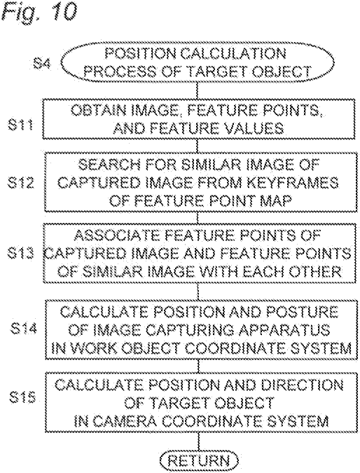

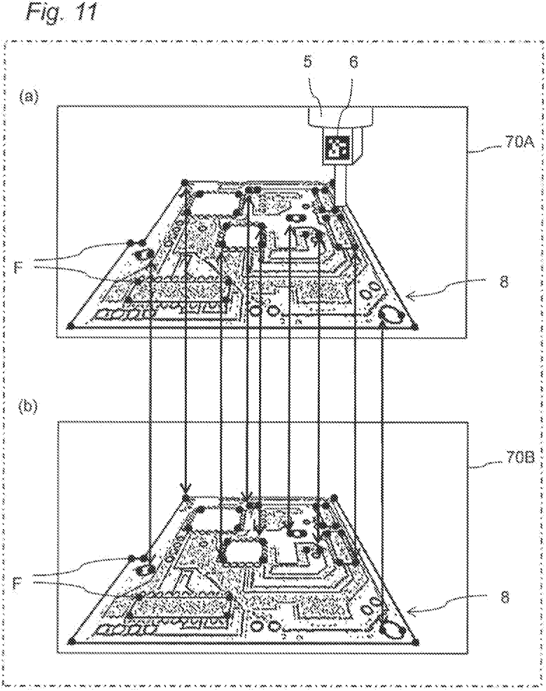

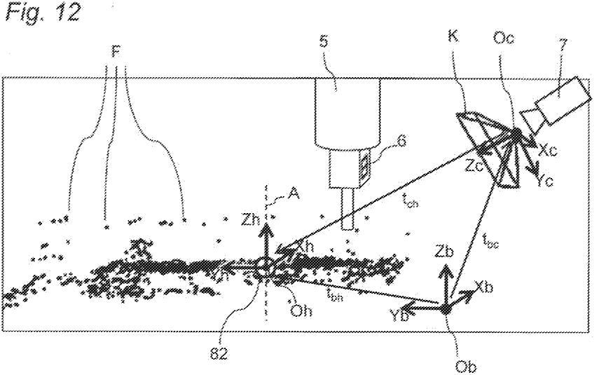

FIG. 10 is a flowchart showing a subroutine of step S4 (position calculation process of target object) of FIG. 9.

The position calculator 12 obtains the captured image, the feature points, and the feature values from the feature point recognizer 11 (step S11).

The position calculator 12 searches for a similar image of the captured image, from the keyframes of the feature point map stored in the storage device 15 (step S12). In this case, the position calculator 12 may read a keyframe as a similar image from the storage device 15 based on the positions and the feature values of the feature points of the captured image obtained by the image capturing apparatus 7, the keyframe including the feature points having similar positions and similar feature values. In a case where the storage device 15 stores the captured images themselves captured to generate the map points, the position calculator 12 may read a keyframe as a similar image from the storage device 15 based on the captured images obtained by the image capturing apparatus 7, the keyframe being associated with a similar captured image.

In order to calculate image similarity, the position calculator 12 may use, for example, Bag of Visual Words (BoVW). The BoVW is a feature vector obtained by clustering local feature values of an image in an n-dimensional space, the feature vector representing features of the image by “the number of occurrences of feature values for each cluster”. The local feature values of the image are feature vectors whose distribution does not change by rotation, enlargement, and reduction. That is, it is expected that an image having a similar distribution of feature values is an image having a similar arrangement of feature points. By obtaining the similarity of the images using the BoVWs calculated for each image, it is possible to search for an image based on the features of the captured object.

The position calculator 12 associates (matches) the feature points of the captured image with the feature points of the similar image (step S13). In order to associate the feature points, the position calculator 12 may use, for example, ORB feature values. In this case, the position calculator 12 calculates the ORB feature value of a certain feature point in the captured image, calculates the ORB feature values of all the feature points in the similar image, and calculates the distance between the ORB feature value of the captured image and each ORB feature value of the similar image (for example, a Hamming distance between the feature vectors). The position calculator 12 associates each pair of feature points corresponding to the feature value with the minimum distance, with each other.

FIG. 11 is diagrams for explaining the feature point association executed in step S13 of FIG. 10, where (a) shows a captured image 70A obtained by the image capturing apparatus 7, and (b) shows a similar image 70B read from the storage device 15. The similar image 70B may include only the feature points F (or, the feature points F and the feature values), or may include the captured image obtained to generate the map points.

The position calculator 12 calculates the position and the posture of the image capturing apparatus 7 in the work object coordinate system (step S14). To this end, the position calculator 12 solves a perspective n point (PnP) problem based on, for example, the positions (two-dimensional coordinates) of the n feature points included in the captured image, and the positions (three-dimensional coordinates) of the n feature points of the map points corresponding to the n feature points included in the similar image.

The position calculator 12 calculates the position and the direction of the screw hole 82 in the camera coordinate system, based on the position and the posture of the image capturing apparatus 7 in the work object coordinate system (step S15).

FIG. 12 is a diagram showing calculation of the position and the direction of the target object in the camera coordinate system, executed in step S15 of FIG. 10. Similarly to FIG. 8, FIG. 12 is a perspective view showing an exemplary feature point map, which is a three-dimensional plot of the plurality of feature points F, and the position and the posture of the image capturing apparatus 7 associated with the keyframes K. In addition, FIG. 12 shows an origin Ob and the coordinate axes Xb, Yb, and Zb of the work object coordinate system, and an origin Oc and the coordinate axes Xc, Yc, and Zc of the camera coordinate system. The direction of the screw hole 82 is represented by the direction of an axis A passing through the screw hole 82 and perpendicular to the surface of the circuit board 8. A vector t_{bh} denotes the position of the screw hole 82 in the work object coordinate system. Since the position of the screw hole 82 is set by the target object setting unit 16, the vector t_{bh} is known. A vector t_{bc} and a matrix R_{bc} (not shown) denote the position and the posture of the image capturing apparatus 7 in the work object coordinate system, respectively. Since the position and the posture of the image capturing apparatus 7 in the work object coordinate system can be calculated by associating the feature points in step S13 of FIG. 10, the vector t_{bc} and the matrix R_{bc} are known. A vector t_{ch} denotes the position of the screw hole 82 in the camera coordinate system. Although the vector t_{ch} is unknown, the vector t_{ch} is calculated by t_{ch} = R_{bc}⁻¹ (t_{bh} - t_{bc}).

In step S13, when the captured image does not include any feature point corresponding to the screw hole 82 being set as the target object, the position calculator 12 ends step S4. Next, the control signal generator 17 outputs a control signal causing the power driver 5 to move to another position, and thus, the image capturing apparatus 7 captures another portion of the circuit board 8. Thereafter, the process returns to step S2.

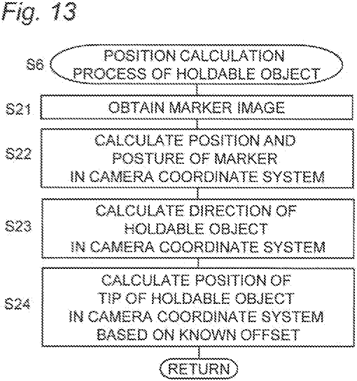

FIG. 13 is a flowchart showing a subroutine of step S6 (position calculation process of holdable object) of FIG. 9.

The position calculator 14 obtains the image of the detected marker 6 from the marker recognizer 13 (step S21).

The position calculator 14 calculates the position and the posture of the marker 6 in the camera coordinate system based on the image of the marker 6 (step S22).

The position calculator 14 calculates the direction of the power driver 5 in the camera coordinate system based on the position and the posture of the marker 6 (step S23).

The position calculator 14 calculates the position of the tip 5a of the power driver 5 in the camera coordinate system, based on a known offset t_{offset} between the marker 6 and the tip 5a of the power driver 5 (step S24).

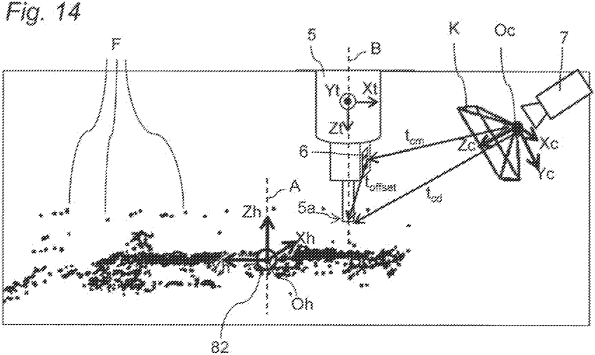

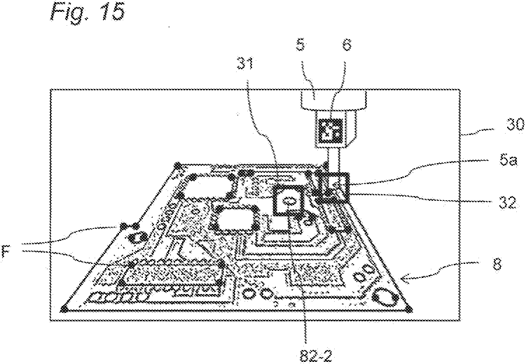

FIG. 14 is a diagram for explaining calculation of the position of the tip 5a of the holdable object in the camera coordinate system, executed in step S24 of FIG. 13. Similarly to FIG. 12, FIG. 14 also shows an exemplary feature point map. The direction of the power driver 5 is represented by the direction of a rotation axis B of the tip 5a of the power driver 5. A vector t_{cm} denotes the position of the marker 6 (for example, the position of the center of the marker 6) in the camera coordinate system. Since the position of the marker 6 in the camera coordinate system is calculated in step S22, the vector t_{cm} is known. As described above, a vector t_{offset} denotes a known offset of the position of the tip 5a of the power driver 5 with respect to the position of the marker 6. A vector t_{cd} denotes the position of the tip 5a of the power driver 5 in the camera coordinate system. Although the vector t_{cd} is unknown, the vector t_{cd} is calculated by t_{cd} = t_{cm} + t_{of}.

In this case, for example, the robot arm apparatus 4 moves the tip 5a of the power driver 5 to the position of the screw hole 82, such that the rotation axis B of the power driver 5 coincides with the axis A of the screw hole 82.

FIG. 15 is a diagram showing an exemplary image 30 displayed on the display apparatus 3 of FIG. 1. The displayed image 30 includes the captured image, the feature points F of the circuit board 8, a frame 31 indicating the recognized target object, and a frame 32 indicating the tip of the recognized holdable object. The example of FIG. 15 shows a case where the screw hole 82-2 is set as the target object. Therefore, the frame 31 is displayed at the position of the screw hole 82-2. In addition, the frame 32 is displayed at the position of the tip 5a of the power driver 5. According to the first embodiment, even when the power driver 5 and the circuit board 8 do not have fixed known positions in the robot coordinate system, it is possible to control the robot arm apparatus 4 to accurately perform work on the circuit board 8 using the power driver 5, by calculating the position and the direction in the robot coordinate system based on the captured image. According to the first embodiment, even when at least one of the power driver 5 and the circuit board 8 moves, it is possible to control the robot arm apparatus 4 to follow the change in the position and the direction thereof, and accurately perform the work on the circuit board 8 using the power driver 5.

### Advantageous Effect and Others of First Embodiment

According to the first embodiment, a control apparatus 1 for controlling a robot arm apparatus 4 that holds a holdable object is provided with: a target object setting unit 16, a feature point recognizer 11, a first position calculator 12, a second position calculator 14, and a control signal generator 17. The target object setting unit 16 sets a position of at least one target object in a work object. The feature point recognizer 11 detects feature points of the work object from a captured image obtained by at least one image capturing apparatus 7, the captured image including at least a part of the work object and a tip of the holdable object. The first position calculator 12 calculates a position of the target object in a coordinate system of the image capturing apparatus 7 based on the feature points of the work object. The second position calculator 14 calculates a position of the tip of the holdable object in the coordinate system of the image capturing apparatus 7 based on the captured image. The control signal generator 17 converts the position of the target object and the position of the tip of the holdable object in the coordinate system of the image capturing apparatus 7, into positions in a coordinate system of the robot arm apparatus 4, and outputs a first control signal to the robot arm apparatus 4 based on the converted position of the target object and the converted position of the tip of the holdable object, the first control signal causing the tip of the holdable object to move to the position of the target object.

With such a configuration, even when at least one of the holdable object and the work object does not have a known fixed position in the robot coordinate system, it is possible to control the robot arm apparatus 4 to accurately perform the work on the work object using the holdable object. For example, even when “a deviation of work object” occurs, in which a part of the robot arm apparatus 4 or the holdable object strikes the work object during the work, and the work object deviates from a workbench fixed to the robot coordinate system, it is possible to accurately perform the work. In addition, even when “mismatch of control” occurs, in which predicted coordinates of the tip of the robot arm apparatus 4 deviate from actual coordinates through repetition of the work, it is possible to accurately perform the work.

According to the first embodiment, the first position calculator 12 may further calculate a direction of the target object in the coordinate system of the image capturing apparatus 7 based on the feature points of the work object. The second position calculator 14 may further calculate a direction of the holdable object in the coordinate system of the image capturing apparatus 7 based on the captured image. In this case, the control signal generator 17 converts the direction of the target object and the direction of the holdable object in the coordinate system of the image capturing apparatus 7, into directions in the coordinate system of the robot arm apparatus 4. The first control signal further includes angle information based on the converted direction of the target object and the converted direction of the holdable object.

With such a configuration, even when at least one of the holdable object and the work object does not have a known fixed direction in the robot coordinate system, it is possible to control the robot arm apparatus 4 to accurately perform the work on the work object using the holdable object.

According to the first embodiment, the control apparatus 1 may be further provided with a first marker recognizer 13 that detects a first marker 6 from the captured image, the first marker 6 being fixed at a known position of the holdable object. In this case, the first marker 6 has a pattern formed such that a position of the first marker 6 in the coordinate system of the image capturing apparatus 7 can be calculated. The second position calculator 14 calculates the position of the tip of the holdable object based on the first marker 6.

With such a configuration, it is possible to calculate the position of the tip of the holdable object in the coordinate system of the image capturing apparatus 7, based on the image of the first marker 6.

According to the first embodiment, the control apparatus 1 may be further provided with a storage device 15 that stores a feature point map in advance, the feature point map including three-dimensional coordinates of a plurality of feature points included in the work object, and two-dimensional coordinates of the plurality of feature points in a plurality of captured images obtained by capturing the work object from a plurality of different positions. In this case, the first position calculator 12 calculates the position of the target object with reference to the feature point map.

With such a configuration, it is possible to calculate the position of the target object in the coordinate system of the image capturing apparatus 7, with reference to the feature point map stored in the storage device 15 in advance.

According to the first embodiment, the image capturing apparatus 7 may be fixed to the robot arm apparatus 4 such that the image capturing apparatus 7 can capture the tip of the holdable object when the robot arm apparatus 4 holds the holdable object.

With such a configuration, the image capturing apparatus 7 can follow the movement of the holdable object.

According to the first embodiment, a robot arm system is provided with: a robot arm apparatus 4; at least one image capturing apparatus 7; and the control apparatus 1.

With such a configuration, With such a configuration, even when at least one of the holdable object and the work object does not have a known fixed position in the robot coordinate system, it is possible to control the robot arm apparatus 4 to accurately perform the work on the work object using the holdable object.

According to the first embodiment, a control method for controlling a robot arm apparatus 4 holding a holdable object is provided. the control method includes setting a position of at least one target object in a work object. The control method includes detecting feature points of the work object from a captured image obtained by at least one image capturing apparatus 7, the captured image including at least a part of the work object and a tip of the holdable object. The control method includes calculating a position of the target object in a coordinate system of the image capturing apparatus 7 based on the feature points of the work object. The control method includes calculating a position of the tip of the holdable object in the coordinate system of the image capturing apparatus 7 based on the captured image. The control method includes converting the position of the target object and the position of the tip of the holdable object in the coordinate system of the image capturing apparatus 7, into positions in a coordinate system of the robot arm apparatus 4, and outputting a control signal to the robot arm apparatus 4 based on the converted position of the target object and the converted position of the tip of the holdable object, the control signal causing the tip of the holdable object to move to the position of the target object.

With such a configuration, With such a configuration, even when at least one of the holdable object and the work object does not have a known fixed position in the robot coordinate system, it is possible to control the robot arm apparatus 4 to accurately perform the work on the work object using the holdable object.

### Second Embodiment

Next, a robot arm system according to a second embodiment is described. In the first embodiment, the position of the target object is calculated with reference to the feature point map of the work object stored in the storage device in advance. On the other hand, in the second embodiment, we will describe a case where the feature point map of the work object is initially unknown.

### Configuration of Second Embodiment Overall Configuration

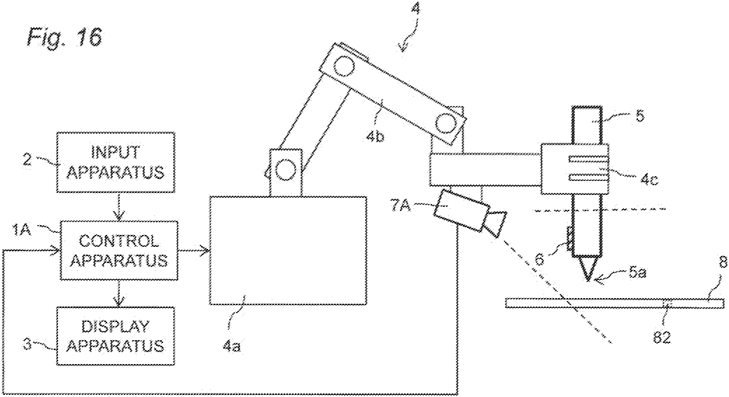

FIG. 16 is a schematic view showing a configuration of the robot arm system according to the second embodiment. The robot arm system of FIG. 16 is provided with a control apparatus 1A and an image capturing apparatus 7A, instead of the control apparatus 1 and the image capturing apparatus 7 of FIG. 1.

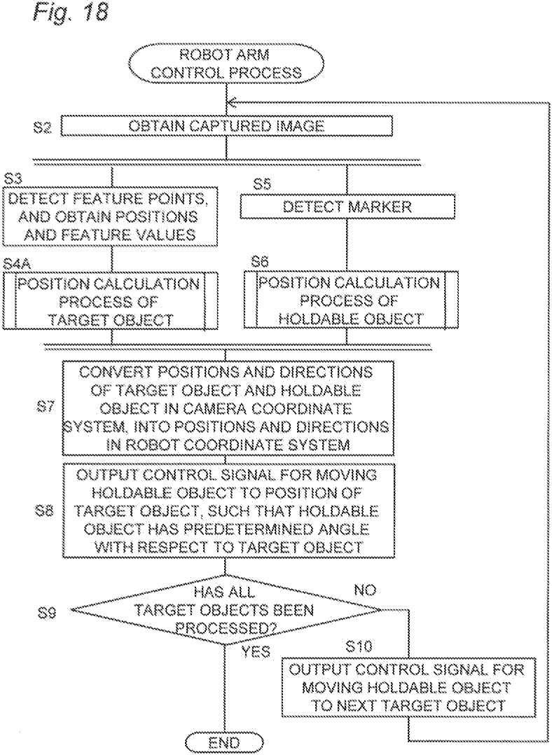

The control apparatus 1A initially does not store the feature point map of the circuit board 8 therein, and executes a robot arm control process of FIG. 18 (described later), instead of the robot arm control process of FIG. 9.

The image capturing apparatus 7A detects distances from the image capturing apparatus 7A to points captured by the image capturing apparatus 7A, as well as obtains the captured image including the at least part of the tip 5a of the power driver 5 and the circuit board 8. The image capturing apparatus 7A is, for example, a stereo camera, an RGB-D camera,or the like.

The other components of the robot arm system of FIG. 16 are configured in a manner similar to that of the corresponding components of the robot arm system of FIG. 1.

### Configuration of Control Apparatus

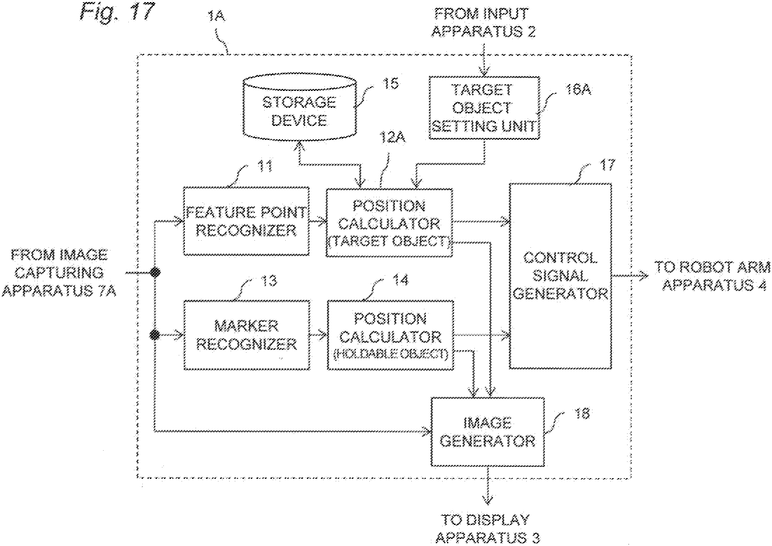

FIG. 17 is a block diagram showing a configuration of the control apparatus 1A of FIG. 16. The control apparatus 1A is provided with a position calculator 12A and a target object setting unit 16A, instead of the position calculator 12 and the target object setting unit 16 of FIG. 5.

The position calculator 12A generates a feature point map of the circuit board 8, based on the captured images and the distances obtained by the image capturing apparatus 7A. The position calculator 12A stores the generated feature point map in the storage device 15. The position calculator 12A calculates the position and the direction of the screw hole 82 in the camera coordinate system, based on the feature points of the circuit board 8 detected by the feature point recognizer 11, and with reference to the generated feature point map.

The target object setting unit 16A sets at least one screw hole 82 in the circuit board 8 as the target object. However, since the feature point map of the circuit board 8 is initially unknown, the target object setting unit 16A may recognize and set the position of the screw hole 82 in the circuit board 8 using, for example, image processing, or may set the position based on user inputs obtained through the input apparatus 2.

The other components of the control apparatus 1A of FIG. 17 are configured in a manner similar to that of the corresponding components of the control apparatus 1 of FIG. 5.

### Operation of Second Embodiment

FIG. 18 is a flowchart showing a robot arm control process executed by the control apparatus 1A of FIG. 16. The process of FIG. 18 does not include step S1 of FIG. 9, and includes step S4A instead of step S4 of FIG. 9.

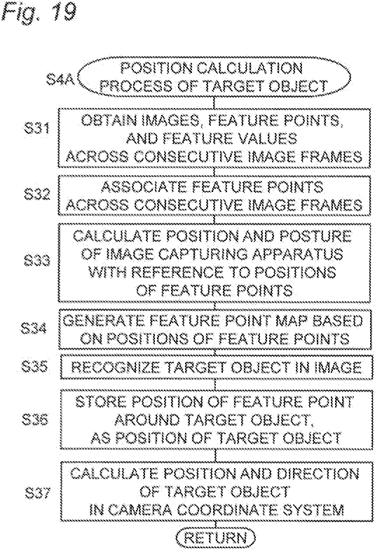

FIG. 19 is a flowchart showing a subroutine of step S4A (position calculation process of target object) of FIG. 18.

The position calculator 12A obtains captured images, feature points, and feature values for at least two consecutive image frames, from the feature point recognizer 11. The position calculator 12A obtains the distances from the image capturing apparatus 7A to points captured by the image capturing apparatus 7A (step S31), as well as the captured image.

The position calculator 12A associates the feature points across the plurality of consecutive image frames (step S32).

The position calculator 12A calculates the position and the posture of the image capturing apparatus 7A with reference to the positions of the feature points (step S33).

The position calculator 12A generates a feature point map based on the positions of the feature points (step S34). The scale of the feature point map is calibrated based on the distances from the image capturing apparatus 7A to the points captured by the image capturing apparatus 7A.

The process of steps S32 to S34 is substantially equivalent to the Visual-SLAM as described above.

The position calculator 12A recognizes the screw hole 82 in the image (step S35).

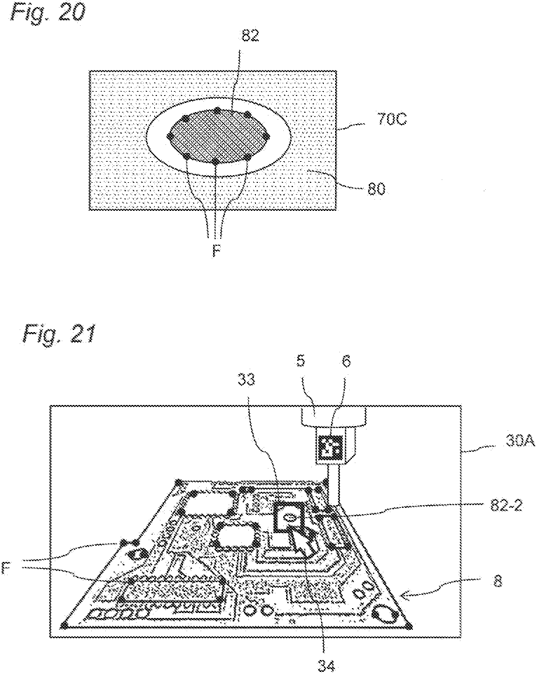

FIG. 20 is a diagram for explaining recognition of the target object using image processing, executed in step S35 of FIG. 19. A plurality of feature points F with a known positional relationship are detected around a desired target object, such as the screw hole 82. Therefore, the target object setting unit 16A may recognize and set the position of the target object in the work object using image processing, such as template matching or deep learning. In the image, the position calculator 12A calculates the position and the direction of the target object set by the target object setting unit 16A.

FIG. 21 is a diagram for explaining recognition of the target object based on the user inputs, executed in step S35 of FIG. 19, the diagram showing an exemplary image 30A displayed on the display apparatus 3 of FIG. 16. When the position calculator 12A recognizes the screw hole 82-2 as a candidate of the target object, the image generator 18 may output an image 30A to the display apparatus 3, the image 30A including a frame 33 indicating the candidate of the target object. The image 30A further includes a cursor 34. The user can set the screw hole 82-2 as an actual target object, by using the input apparatus 2 to operate the cursor 34 and select the frame 33. The target object setting unit 16A sets the position of the target object in the work object based on the user inputs obtained through the input apparatus 2. In the image, the position calculator 12A calculates the position and the direction of the target object set by the target object setting unit 16A.

Referring again to FIG. 19, the position calculator 12A stores the position of the recognized target object, that is, the position of the feature point around the screw hole 82, in the storage device 15, as the position of the target object (step S35).

The position calculator 12A calculates the position and the direction of the screw hole 82 in the camera coordinate system, based on the position and the posture of the image capturing apparatus 7A in the work object coordinate system (step S37).

According to the second embodiment, even when the feature point map of the work object is initially unknown, it is possible to generate the feature point map of the work object based on the captured images obtained by the image capturing apparatus 7A, and calculate the position of the target object with reference to the generated feature point map.

In addition, according to the second embodiment, once the feature point map is generated and stored in the storage device 15, it is possible to reuse the feature point map for the circuit board 8 of the same type as that for which the feature point map is generated. Therefore, once the feature point map is generated and stored in the storage device 15, then the control apparatus 1A can operate with reference to the feature point map stored in the storage device 15, in a manner similar to that of the control apparatus according to the first embodiment (that is, the robot arm control process of FIG. 9 can be executed).

### Advantageous Effect and Others of Second Embodiment

According to the second embodiment, a control apparatus 1A for controlling a robot arm apparatus 4 that holds a holdable object, is provided with: a target object setting unit 16A, a feature point recognizer 11, a first position calculator 12A, a second position calculator 14, and a control signal generator 17. The target object setting unit 16A sets a position of at least one target object in a work object. The feature point recognizer 11 detects feature points of the work object from a captured image obtained by at least one image capturing apparatus 7A, the captured image including at least a part of the work object and a tip of the holdable object. The first position calculator 12A calculates a position of the target object in a coordinate system of the image capturing apparatus 7A based on the feature points of the work object. The second position calculator 14 calculates a position of the tip of the holdable object in the coordinate system of the image capturing apparatus 7A based on the captured image. The control signal generator 17 converts the position of the target object and the position of the tip of the holdable object in the coordinate system of the image capturing apparatus 7A, into positions in a coordinate system of the robot arm apparatus 4, and outputs a first control signal to the robot arm apparatus 4 based on the converted position of the target object and the converted position of the tip of the holdable object, the first control signal causing the tip of the holdable object to move to the position of the target object.

With such a configuration, even when at least one of the holdable object and the work object does not have a known fixed position in the robot coordinate system, it is possible to control the robot arm apparatus 4 to accurately perform the work on the work object using the holdable object.

According to the second embodiment, the first position calculator 12A may further calculate a direction of the target object in the coordinate system of the image capturing apparatus 7A based on the feature points of the work object. The second position calculator 14 may further calculate a direction of the holdable object in the coordinate system of the image capturing apparatus 7A based on the captured image. In this case, the control signal generator 17 converts the direction of the target object and the direction of the holdable object in the coordinate system of the image capturing apparatus 7A, into directions in the coordinate system of the robot arm apparatus 4. The first control signal further includes angle information based on the converted direction of the target object and the converted direction of the holdable object.

With such a configuration, even when at least one of the holdable object and the work object does not have a known fixed direction in the robot coordinate system, it is possible to control the robot arm apparatus 4 to accurately perform the work on the work object using the holdable object.

According to the second embodiment, the control apparatus 1A may be further provided with a first marker recognizer 13 that detects a first marker 6 from the captured image, the first marker 6 being fixed at a known position of the holdable object. In this case, the first marker 6 has a pattern formed such that a position of the first marker 6 in the coordinate system of the image capturing apparatus 7A can be calculated. The second position calculator 14 calculates the position of the tip of the holdable object based on the first marker 6.

With such a configuration, it is possible to calculate the position of the tip of the holdable object in the coordinate system of the image capturing apparatus 7A, based on the image of the first marker 6.

According to the second embodiment, the image capturing apparatus 7A may further obtain distances from the image capturing apparatus 7A to points captured by the image capturing apparatus 7A. The first position calculator 12A generates a feature point map based on the captured image and the distances, the feature point map including three-dimensional coordinates of a plurality of feature points included in the work object, and two-dimensional coordinates of the plurality of feature points in a plurality of captured images obtained by capturing the work object from a plurality of different positions. The first position calculator 12A calculates the position of the target object with reference to the feature point map.

With such a configuration, it is possible to generate the feature point map of the work object based on the captured images obtained by the image capturing apparatus 7A, and calculate the position of the target object with reference to the generated feature point map.

According to the second embodiment, the control apparatus 1A may be further provided with a storage device 15 that stores the feature point map generated by the first position calculator 12A.

With such a configuration, once the feature point map is generated and stored in the storage device 15, then the control apparatus 1A can operate with reference to the feature point map stored in the storage device 15, in a manner similar to that of the first embodiment.

According to the second embodiment, the target object setting unit 16A may recognize and sets the position of the target object in the work object using image processing.

With such a configuration, even when the feature point map of the work object is initially unknown, it is possible to set the position of the target object in the work object.

According to the second embodiment, the target object setting unit 16A sets the position of the target object in the work object based on a user input obtained through an input apparatus 2.

With such a configuration, even when the feature point map of the work object is initially unknown, it is possible to set the position of the target object in the work object.

According to the second embodiment, the image capturing apparatus 7A may be fixed to the robot arm apparatus 4 such that the image capturing apparatus 7A can capture the tip of the holdable object when the robot arm apparatus 4 holds the holdable object.

With such a configuration, the image capturing apparatus 7A can follow the movement of the holdable object.

According to the second embodiment, a robot arm system is provided with: a robot arm apparatus 4; at least one image capturing apparatus 7A; and the control apparatus 1A.

With such a configuration, even when at least one of the holdable object and the work object does not have a known fixed position in the robot coordinate system, it is possible to control the robot arm apparatus 4 to accurately perform the work on the work object using the holdable object.

### Third Embodiment

Next, a robot arm system according to a third embodiment is described. In the first and second embodiments, the position of the tip of the holdable object is calculated based on the marker fixed at the known position of the holdable object. On the other hand, in the third embodiment, we will describe a case where the position of the tip of the holdable object is calculated without using the marker.

### Configuration of Third Embodiment Overall Configuration

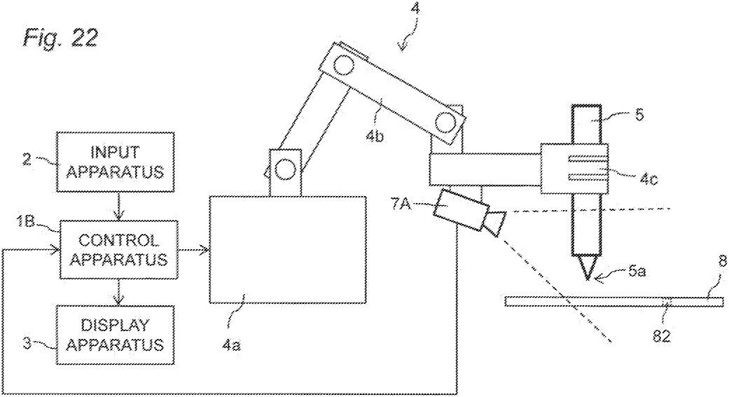

FIG. 22 is a schematic view showing a configuration of a robot arm system according to the third embodiment. The robot arm system of FIG. 22 does not includes the marker 6 of FIG. 16, and is provided with a control apparatus 1B instead of the control apparatus 1A of FIG. 16.

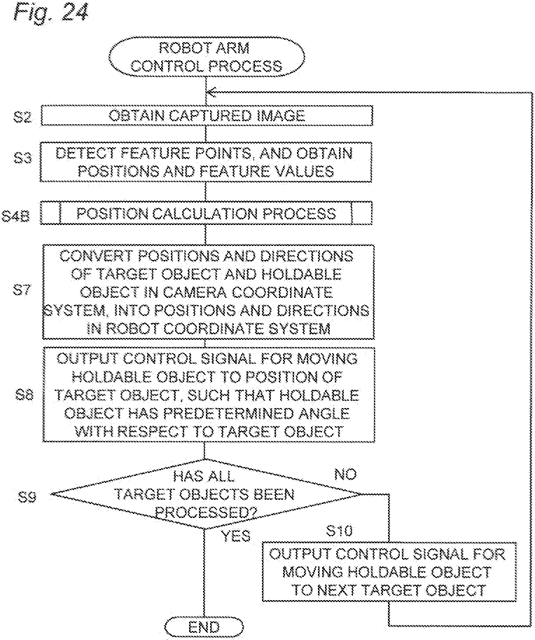

The control apparatus 1B executes a robot arm control process of FIG. 24 (described later), instead of the robot arm control process of FIG. 18.

The other components of the robot arm system of FIG. 22 are configured in a manner similar to that of the corresponding components of the robot arm system of FIG. 16.

### Configuration of Control Apparatus

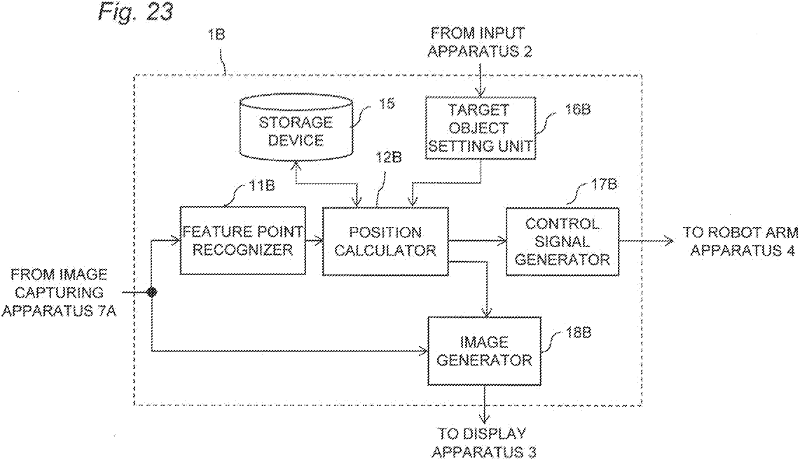

FIG. 23 is a block diagram showing a configuration of the control apparatus 1B of FIG. 22. The control apparatus 1B is provided with a feature point recognizer 11B, a position calculator 12B, a storage device 15, a target object setting unit 16B, a control signal generator 17B, and an image generator 18B.

The feature point recognizer 11B detects feature points of the circuit board 8 from the captured image obtained by the image capturing apparatus 7, and further detects feature points of the power driver 5 from the captured image.

The position calculator 12B generates a feature point map of the circuit board 8, and calculates the position and the direction of the screw hole 82 in the camera coordinate system, in a manner similar to that of the position calculator 12A of FIG. 17. The position calculator 12B further calculates the direction of the power driver 5 and the position of the tip 5a of the power driver 5, based on the feature points of the power driver 5 detected by the feature point recognizer 11, and based on the distances from the image capturing apparatus 7A to points captured by the image capturing apparatus 7A, the distance being detected by the image capturing apparatus 7A.

Since the position calculator 12B calculates the position of the target object and the position of the tip of the holdable object, it can be said that the position calculator 12B has functions of both the position calculators 12A and 14 of FIG. 17 (alternatively, the position calculators 12 and 14 of FIG. 1).

The target object setting unit 16B sets at least one screw hole 82 in the circuit board 8 as the target object, in a manner similar to that of the target object setting unit 16A of FIG. 17. In addition, in the third embodiment, the marker fixed at the known position of the power driver 5 is not used, and the position of the tip 5a of the power driver 5 cannot be calculated based on the image of the marker. Therefore, the target object setting unit 16B may further set the position of the tip 5a of the power driver 5. The target object setting unit 16B may recognize and set the position of the tip 5a of the power driver 5 using, for example, image processing, or may set the position based on user inputs obtained through the input apparatus 2.

The storage device 15 of FIG. 23 is configured in a manner similar to that of the storage device 15 of FIG. 17. The control signal generator 17B and the image generator 18B of FIG. 23 are configured in a manner similar to that of the corresponding components of FIG. 17, except obtaining the position of the screw hole 82 and the position of the tip 5a of the power driver 5 from the single position calculator 12B, instead of obtaining the positions from the position calculators 12A and 14 of FIG. 17.

### Operation of Third Embodiment

FIG. 24 is a flowchart showing a robot arm control process executed by the control apparatus 1B of FIG. 22. The process of FIG. 24 does not include steps S5 and S6 of FIG. 18, and includes step S4B instead of step S4A of FIG. 18.

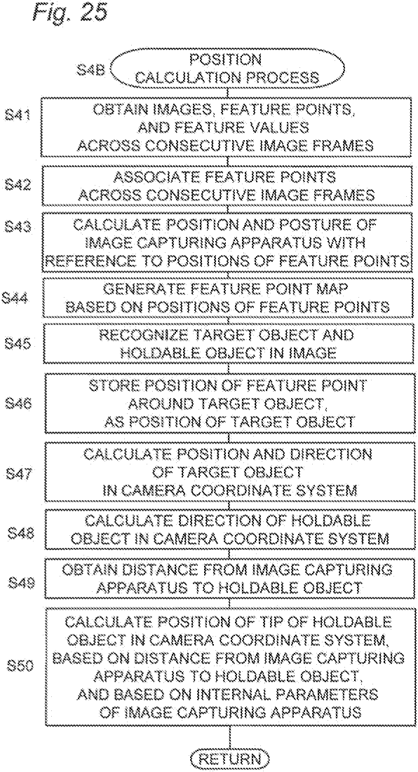

FIG. 25 is a flowchart showing a subroutine of step S4B (position calculation process) of FIG. 24.

Steps S41 to S44 of FIG. 25 are similar to steps S31 to S34 of FIG. 19.

The position calculator 12B recognizes the screw hole 82 and the tip of the power driver 5 in the image (step S45). The target object setting unit 16B may recognize and set the position of the target object in the work object, and the position of the tip of the holdable object, using image processing, such as template matching, deep learning, or the like. In addition, the target object setting unit 16B may set the position of the target object in the work object, and the position of the tip of the holdable object, based on the user inputs obtained through the input apparatus 2. In the image, the position calculator 12B recognizes the target object set by the target object setting unit 16B, and the tip of the holdable object.

The position calculator 12B stores the position of the recognized target object, that is, the position of the feature point around the screw hole 82, in the storage device 15, as the position of the target object (step S46).

The position calculator 12B calculates the position and the direction of the screw hole 82 in the camera coordinate system, based on the position and the posture of the image capturing apparatus 7A in the work object coordinate system (step S47).

The position calculator 12B calculates the direction of the power driver 5 in the camera coordinate system based on the feature points of the power driver 5 (step S48).

The position calculator 12B obtains the distance from the image capturing apparatus 7A to the power driver 5, based on the distances from the image capturing apparatus 7A to points captured by the image capturing apparatus 7A (step S49). In general, it is considered that the lower region of the captured image corresponds to the circuit board 8, and a part of the upper region of the captured image, having a small distance from the image capturing apparatus 7A, corresponds to the power driver 5. In addition, it is considered that in the captured image, the lower end of the region of the power driver 5 corresponds to the tip 5a of the power driver 5.

The position calculator 12B calculates the position of the tip 5a of the power driver 5 in the camera coordinate system, based on the distance from the image capturing apparatus 7A to the power driver 5, and based on internal parameters of the image capturing apparatus 7 (step S50). The internal parameters of the image capturing apparatus 7 include, for example, the focal length of the image capturing apparatus 7, and the coordinates of the center of the image. Here, (x, y) denote the coordinates of the tip 5a of the power driver 5 in the captured image, d denotes the distance from the image capturing apparatus 7A to the power driver 5, (fₓ, f_{y}) denote the focal length of the image capturing apparatus 7, and (cₓ, c_{y}) denote the coordinates of the center of the image of the image capturing apparatus 7. In this case, the position (x_{c}, y_{c}, z_{c}) of the tip 5a of the power driver 5 in the camera coordinate system is given as follows.

$${\text{x}}_{\text{c}} = \left(\text{x} \text{-} {\text{c}}_{\text{x}}\right) \times \left(\text{d} / {\text{f}}_{\text{x}}\right)$$

$${\text{y}}_{\text{c}} = \left(\text{y} \text{-} {\text{c}}_{\text{y}}\right) \times \left(\text{d} / {\text{f}}_{\text{y}}\right)$$

$${\text{z}}_{\text{c}} = \text{d}$$

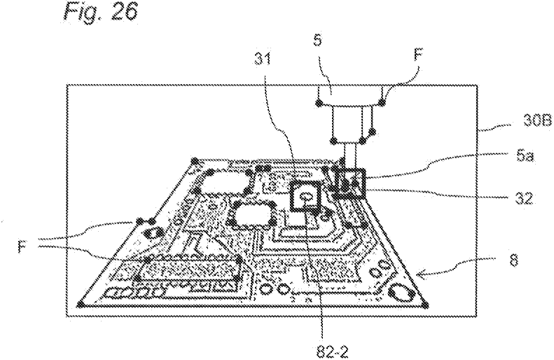

FIG. 26 is a diagram showing an exemplary image 30B displayed on the display apparatus 3 of FIG. 22. According to the third embodiment, even when the marker fixed at the known position of the power driver 5 is not used, it is possible to calculate the position of the tip 5a of the power driver 5 based on feature points F of the power driver 5 detected from the captured image, as shown in FIG. 26.

In addition, according to the third embodiment, once the feature point map is generated and stored in the storage device 15, then the control apparatus 1B can operate with reference to the feature point map stored in the storage device 15, in a manner similar to that of the control apparatus according to the first embodiment as to the calculation of the position of the target object.

### Advantageous Effect and Others of Third Embodiment

According to the third embodiment, a control apparatus 1B for controlling a robot arm apparatus 4 that holds a holdable object is provided with: a target object setting unit 16B, a feature point recognizer 11B, a position calculator 12B, and a control signal generator 17B. The target object setting unit 16B sets a position of at least one target object in a work object. The feature point recognizer 11B detects feature points of the work object from a captured image obtained by at least one image capturing apparatus 7A, the captured image including at least a part of the work object and a tip of the holdable object. The position calculator 12B calculates a position of the target object in a coordinate system of the image capturing apparatus 7A based on the feature points of the work object. The position calculator 12B calculates a position of the tip of the holdable object in the coordinate system of the image capturing apparatus 7A based on the captured image. The control signal generator 17B converts the position of the target object and the position of the tip of the holdable object in the coordinate system of the image capturing apparatus 7A, into positions in a coordinate system of the robot arm apparatus 4, and outputs a first control signal to the robot arm apparatus 4 based on the converted position of the target object and the converted position of the tip of the holdable object, the first control signal causing the tip of the holdable object to move to the position of the target object.

With such a configuration, even when at least one of the holdable object and the work object does not have a known fixed position in the robot coordinate system, it is possible to control the robot arm apparatus 4 to accurately perform the work on the work object using the holdable object.

According to the third embodiment, the position calculator 12B may further calculate a direction of the target object in the coordinate system of the image capturing apparatus 7A based on the feature points of the work object. The position calculator 12B may further calculate a direction of the holdable object in the coordinate system of the image capturing apparatus 7A based on the captured image. In this case, the control signal generator 17B converts the direction of the target object and the direction of the holdable object in the coordinate system of the image capturing apparatus 7A, into directions in the coordinate system of the robot arm apparatus 4. The first control signal further includes angle information based on the converted direction of the target object and the converted direction of the holdable object.

With such a configuration, even when at least one of the holdable object and the work object does not have a known fixed direction in the robot coordinate system, it is possible to control the robot arm apparatus 4 to accurately perform the work on the work object using the holdable object.

According to the third embodiment, the image capturing apparatus 7A may further obtain distances from the image capturing apparatus 7A to points captured by the image capturing apparatus 7A. In this case, the feature point recognizer 11B further detects feature points of the holdable object from the captured image. The position calculator 12 calculates the position of the tip of the holdable object based on the feature points of the holdable object and the distances.

With such a configuration, even when the marker fixed at the known position of the holdable object is not used, it is possible to calculate the position of the tip of the holdable object.

According to the third embodiment, the image capturing apparatus 7A may further obtain distances from the image capturing apparatus 7A to points captured by the image capturing apparatus 7A. The position calculator 12B generates a feature point map based on the captured image and the distances, the feature point map including three-dimensional coordinates of a plurality of feature points included in the work object, and two-dimensional coordinates of the plurality of feature points in a plurality of captured images obtained by capturing the work object from a plurality of different positions. The position calculator 12B calculates the position of the target object with reference to the feature point map.

With such a configuration, it is possible to generate the feature point map of the work object based on the captured images obtained by the image capturing apparatus 7A, and calculate the position of the target object with reference to the generated feature point map.

According to the third embodiment, the control apparatus 1B may be further provided with a storage device 15 that stores the feature point map generated by the position calculator 12B.

With such a configuration, once the feature point map is generated and stored in the storage device 15, then the control apparatus 1B can operate with reference to the feature point map stored in the storage device 15, in a manner similar to that of the first embodiment as to the calculation of the position of the target object.

According to the third embodiment, the target object setting unit 16B may recognize and sets the position of the target object in the work object using image processing.

With such a configuration, even when the feature point map of the work object is initially unknown, it is possible to set the position of the target object in the work object.

According to the third embodiment, the target object setting unit 16B sets the position of the target object in the work object based on a user input obtained through an input apparatus 2.

With such a configuration, even when the feature point map of the work object is initially unknown, it is possible to set the position of the target object in the work object.

According to the third embodiment, the image capturing apparatus 7A may be fixed to the robot arm apparatus 4 such that the image capturing apparatus 7A can capture the tip of the holdable object when the robot arm apparatus 4 holds the holdable object.

With such a configuration, the image capturing apparatus 7A can follow the movement of the holdable object.

According to the third embodiment, a robot arm system is provided with: a robot arm apparatus 4; at least one image capturing apparatus 7A; and the control apparatus 1B.

With such a configuration, even when at least one of the holdable object and the work object does not have a known fixed position in the robot coordinate system, it is possible to control the robot arm apparatus 4 to accurately perform the work on the work object using the holdable object.

### Fourth Embodiment

Next, a robot arm system according to a fourth embodiment is described. In the second and third embodiments, the image capturing apparatus, such as a stereo camera, an RGB-D camera, or the like, is used to obtain the distances from the image capturing apparatus to points captured by the image capturing apparatus, and the feature point map of the work object is generated based on the captured images and the distances. On the other hand, in the fourth embodiment, we will describe a case where a feature point map of a work object is generated without obtaining distances from an image capturing apparatus to points captured by the image capturing apparatus.

### Configuration of Fourth Embodiment Overall Configuration

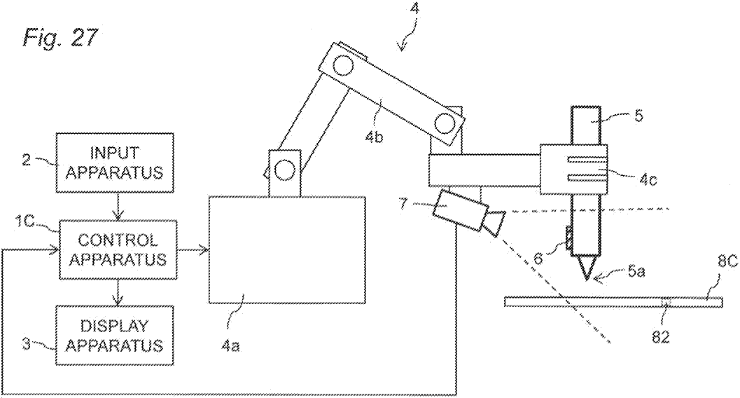

FIG. 27 is a schematic view showing a configuration of a robot arm system according to the fourth embodiment. The robot arm system of FIG. 27 is provided with a control apparatus 1C and a circuit board 8C, instead of the control apparatus 1 and the circuit board 8 of FIG. 1.

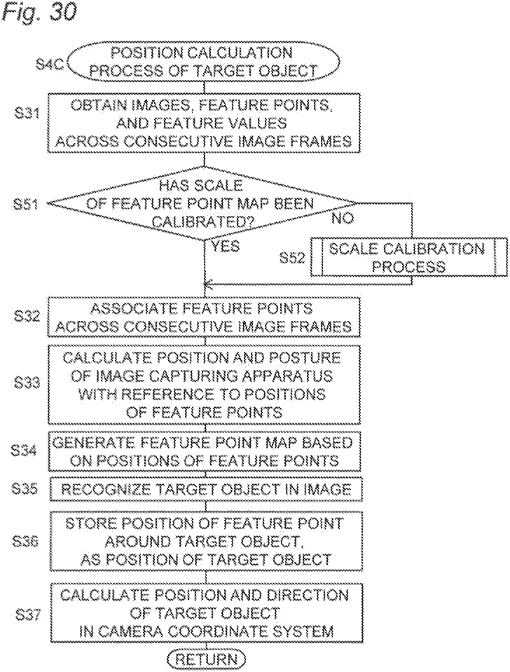

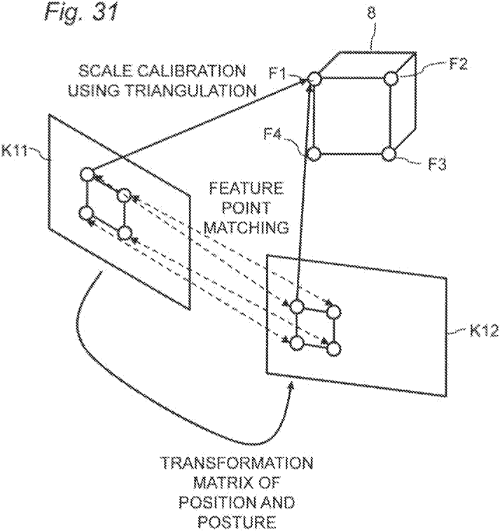

The control apparatus 1C executes the process similar to that of the robot arm control process of FIG. 18, except for executing a position calculation process of FIG. 30 (described later), instead of step S4A (position calculation process) of FIG. 18.

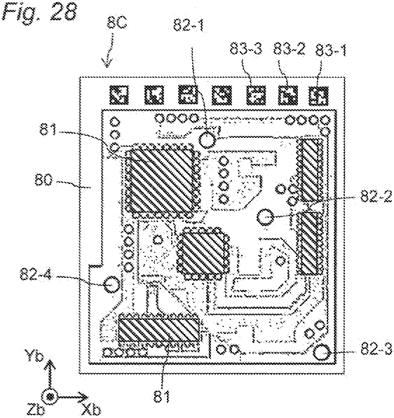

FIG. 28 is a plan view showing the circuit board 8C of FIG. 27. The circuit board 8C is provided with a plurality of markers 83-1, 83-2,... (also collectively referred to as the “marker 83”) fixed at known positions, as well as to the components of the circuit board 8 of FIG. 3. Each marker 83 has a pattern formed such that the direction and the distance of the marker 83 as seen from the image capturing apparatus 7 can be calculated, in a manner similar to that of the marker 6 of FIG. 1.

The other components of the robot arm system of FIG. 27 are configured in a manner similar to that of the corresponding components of the robot arm system of FIG. 1. In particular, the image capturing apparatus 7 may be a monocular camera or the like without the function of detecting distances from the image capturing apparatus 7 to points captured by the image capturing apparatus 7, as described above.

### Configuration of Control Apparatus

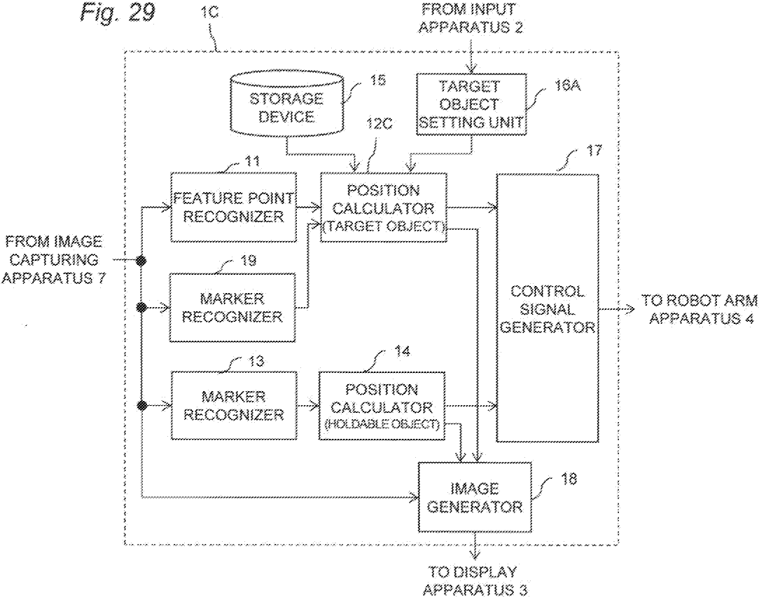

FIG. 29 is a block diagram showing a configuration of the control apparatus 1C of FIG. 27. The control apparatus 1C is provided with a position calculator 12C instead of the position calculator 12A of FIG. 17, and further provided with a marker recognizer 19.

The marker recognizer 19 detects the markers 83 fixed at known positions in the circuit board 8C, from the captured image.

The position calculator 12C generates a feature point map of the circuit board 8C, and calculates the position and the direction of the screw hole 82 in the camera coordinate system, in a manner similar to that of the position calculator 12A of FIG. 17. However, since the distances from the image capturing apparatus 7 to points captured by the image capturing apparatus 7 are not obtained in the fourth embodiment, the position calculator 12C calculates the distance from the image capturing apparatus 7 to the work object, based on the images of the markers 83 detected by the marker recognizer 19 instead. The position calculator 12C generates a feature point map of the circuit board 8C based on the captured images and the distance. The position calculator 12C calculates the position and the direction of the screw hole 82 in the camera coordinate system with reference to the feature point map, as described above.

The other components of the control apparatus 1C of FIG. 29 are configured in a manner similar to that of the corresponding components of the control apparatus 1A of FIG. 17.

### Operation of Fourth Embodiment

FIG. 30 is a flowchart showing a position calculation process executed by the position calculator 12C of FIG. 29. The position calculation process of FIG. 30 further includes steps S51 and S52, between steps S31 and S32 of FIG. 19.

The position calculator 12C determines whether or not the scale of the feature point map has been calibrated (step S51): if YES, the process proceeds to step S42; if NO, the process proceeds to step S52. In this case, the scale calibration means calibrating a conversion coefficient for converting a length in the captured image (for example, in the number of pixels) into an actual length (for example, in millimeter).

The position calculator 12C executes a scale calibration process (step S52).

FIG. 31 is a diagram for explaining calibration of a scale of a feature point map according to a comparison example. In a case where the image capturing apparatus 7 is a monocular camera, and no marker is used, the scale is calibrated, for example, as follows.

(1) The feature points and the feature values of the first image frame are obtained.

The feature points and the feature values of the second image frame are obtained.

The feature points of the first and second image frames are associated with each other.

An F matrix (basic matrix) is calculated by the eight-point algorithm, and a transformation matrix of the position and the posture of the image capturing apparatus between when obtaining the first image frame and when obtaining the second image frame (image capturing apparatuses represented by keyframes K11 and K12 of FIG. 31) is calculated.

The scale of the feature point map is calibrated using triangulation.

According to the example of FIG. 31, since the unit of the length associated with the transformation matrix of the position and posture is unknown, the unit of the vector indicating the map point is also unknown, as a result. the scale of the feature point map cannot be calibrated correctly. Therefore, in the fourth embodiment, the scale of the feature point map is calibrated as follows.

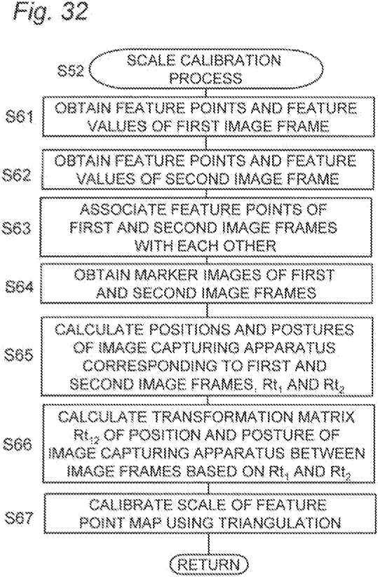

FIG. 32 is a flowchart showing a subroutine of step S52 (scale calibration process) of FIG. 30.

The position calculator 12C obtains the feature points and the feature values of the first image frame (step S61).

The position calculator 12C obtains the feature points and the feature values of the second image frame (step S62).

The position calculator 12C associates the feature points of the first and second image frames with each other (step S63).

The position calculator 12C obtains the images of the marker 83 in the first and second image frames (step S64).

The position calculator 12C calculates matrices Rt₁ and Rt₂ representing the positions and the postures of the image capturing apparatus 7 corresponding to the first and second image frames, in the coordinate system with the origin at the center of the marker 83 (step S65).

The position calculator 12C calculates a transformation matrix Rt₁₂ of the position and the posture of the image capturing apparatus 7 between the image frames, based on the matrices Rt₁ and Rt₂ (step S66). The transformation matrix Rt₁₂ is given by Rt₁₂ = Rt₂ Rt₁⁻¹.

The position calculator 12C calibrates the scale of the feature point map using the triangulation (step S67).

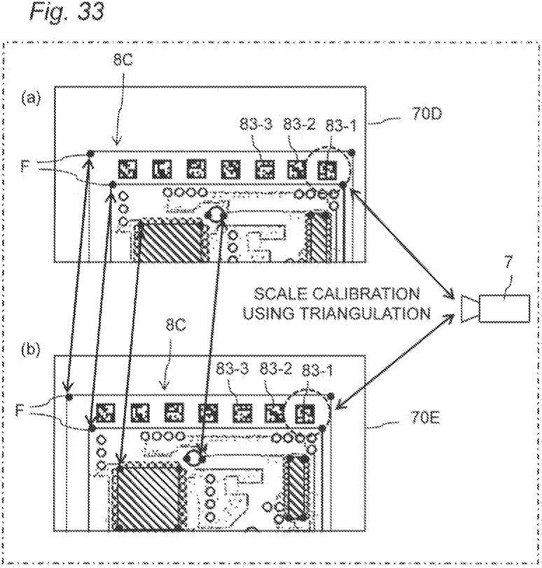

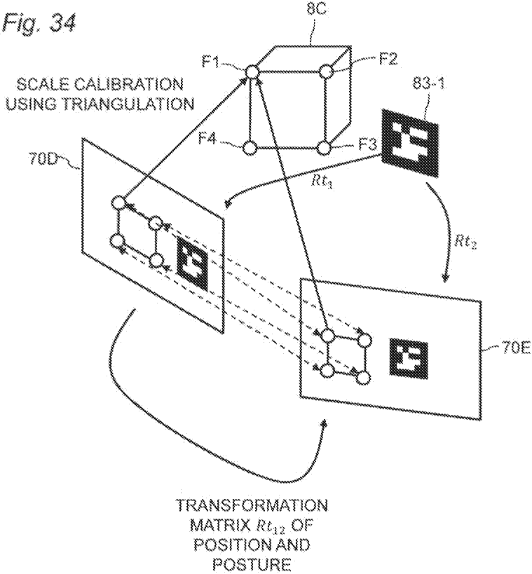

FIG. 33 is a diagram for explaining the association of the feature points, executed in step S63 of FIG. 32. FIG. 34 is a diagram for explaining the calibration of the scale of the feature point map, executed in step S67 of FIG. 32. As shown in FIGS. 33 and 34, captured images 70D and 70E include the same marker 83-1. By performing the triangulation based on the image of the marker 83-1, it is possible to correctly calibrate the scale of the feature point map.

According to the fourth embodiment, even when using the image capturing apparatus 7 without function of detecting the distance, it is possible to correctly calibrate the scale of the feature point map using the marker 83-1 and the like.

According to the fourth embodiment, it is possible to generate the feature point map of the work object, without obtaining the distances from the image capturing apparatus to points captured by the image capturing apparatus, that is, without using an expensive image capturing apparatus, such as a stereo camera, an RGB-D camera, or the like.

### Advantageous Effect and Others of Fourth Embodiment

According to the fourth embodiment, a control apparatus 1C for controlling a robot arm apparatus 4 that holds a holdable object is provided with: a target object setting unit 16A, a feature point recognizer 11, a first position calculator 12C, a second position calculator 14, and a control signal generator 17. The target object setting unit 16A sets a position of at least one target object in a work object. The feature point recognizer 11 detects feature points of the work object from a captured image obtained by at least one image capturing apparatus 7, the captured image including at least a part of the work object and a tip of the holdable object. The first position calculator 12C calculates a position of the target object in a coordinate system of the image capturing apparatus 7 based on the feature points of the work object. The second position calculator 14 calculates a position of the tip of the holdable object in the coordinate system of the image capturing apparatus 7 based on the captured image. The control signal generator 17 converts the position of the target object and the position of the tip of the holdable object in the coordinate system of the image capturing apparatus 7, into positions in a coordinate system of the robot arm apparatus 4, and outputs a first control signal to the robot arm apparatus 4 based on the converted position of the target object and the converted position of the tip of the holdable object, the first control signal causing the tip of the holdable object to move to the position of the target object.

With such a configuration, even when at least one of the holdable object and the work object does not have a known fixed position in the robot coordinate system, it is possible to control the robot arm apparatus 4 to accurately perform the work on the work object using the holdable object.

According to the fourth embodiment, the first position calculator 12C may further calculate a direction of the target object in the coordinate system of the image capturing apparatus 7 based on the feature points of the work object. The second position calculator 14 may further calculate a direction of the holdable object in the coordinate system of the image capturing apparatus 7 based on the captured image. In this case, the control signal generator 17 converts the direction of the target object and the direction of the holdable object in the coordinate system of the image capturing apparatus 7, into directions in the coordinate system of the robot arm apparatus 4. The first control signal further includes angle information based on the converted direction of the target object and the converted direction of the holdable object.

With such a configuration, even when at least one of the holdable object and the work object does not have a known fixed direction in the robot coordinate system, it is possible to control the robot arm apparatus 4 to accurately perform the work on the work object using the holdable object.

According to the fourth embodiment, the control apparatus 1C may be further provided with a first marker recognizer 13 that detects a first marker 6 from the captured image, the first marker 6 being fixed at a known position of the holdable object. In this case, the first marker 6 has a pattern formed such that a position of the first marker 6 in the coordinate system of the image capturing apparatus 7 can be calculated. The second position calculator 14 calculates the position of the tip of the holdable object based on the first marker 6.

With such a configuration, it is possible to calculate the position of the tip of the holdable object in the coordinate system of the image capturing apparatus 7, based on the image of the first marker 6.

According to the fourth embodiment, the control apparatus 1C may be further provided with a second marker recognizer 19 that detects at least one second marker 83 from the captured image, the second marker 83 being fixed at a known position of the work object. In this case, the second marker 83 has a pattern formed such that a position of the second marker 83 in the coordinate system of the image capturing apparatus 7 can be calculated. The first position calculator 12C calculates a distance from the image capturing apparatus 7 to the work object based on the second marker 83. The first position calculator 12C generates a feature point map based on the captured image and the distance, the feature point map including three-dimensional coordinates of a plurality of feature points included in the work object, and two-dimensional coordinates of the plurality of feature points in a plurality of captured images obtained by capturing the work object from a plurality of different positions. The first position calculator 12C calculates the position of the target object with reference to the feature point map.

With such a configuration, it is possible to generate the feature point map of the work object based on the captured images obtained by the image capturing apparatus 7, and calculate the position of the target object with reference to the generated feature point map.

According to the fourth embodiment, the control apparatus 1C may be further provided with a storage device 15 that stores the feature point map generated by the first position calculator 12C.

With such a configuration, once the feature point map is generated and stored in the storage device 15, then the control apparatus 1C can operate with reference to the feature point map stored in the storage device 15, in a manner similar to that of the first embodiment as to the calculation of the position of the target object.

According to the fourth embodiment, the target object setting unit 16A may recognize and sets the position of the target object in the work object using image processing.

With such a configuration, even when the feature point map of the work object is initially unknown, it is possible to set the position of the target object in the work object.

According to the fourth embodiment, the target object setting unit 16A sets the position of the target object in the work object based on a user input obtained through an input apparatus 2.

With such a configuration, even when the feature point map of the work object is initially unknown, it is possible to set the position of the target object in the work object.

According to the fourth embodiment, the image capturing apparatus 7 may be fixed to the robot arm apparatus 4 such that the image capturing apparatus 7 can capture the tip of the holdable object when the robot arm apparatus 4 holds the holdable object.

With such a configuration, the image capturing apparatus 7 can follow the movement of the holdable object.

According to the fourth embodiment, a robot arm system is provided with: a robot arm apparatus 4; at least one image capturing apparatus 7; and the control apparatus 1C.

With such a configuration, even when at least one of the holdable object and the work object does not have a known fixed position in the robot coordinate system, it is possible to control the robot arm apparatus 4 to accurately perform the work on the work object using the holdable object.

### Fifth Embodiment

Next, a robot arm system according to a fifth embodiment is described. In the first to fourth embodiments, one image capturing apparatus fixed to the robot arm apparatus is used. On the other hand, in the fifth embodiment, we will describe a case of using a plurality of image capturing apparatuses fixed at positions other than the position of the robot arm apparatus.

### Configuration of Fifth Embodiment

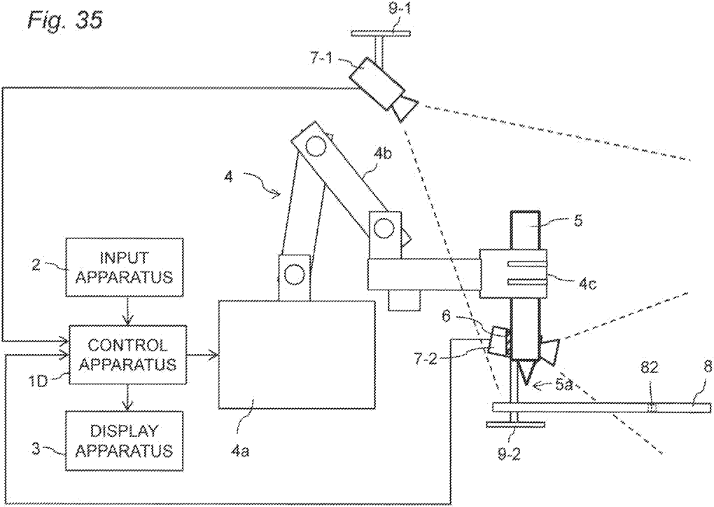

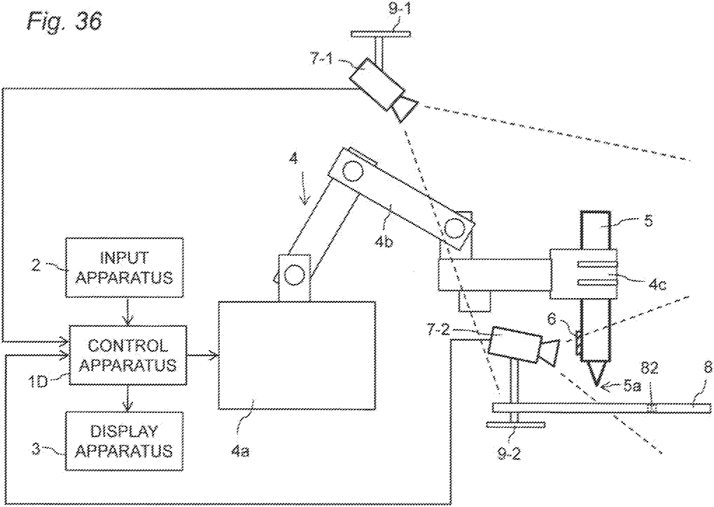

FIGS. 35 and 36 are schematic views showing a configuration of the robot arm system according to the fifth embodiment. FIG. 35 shows a case in which the holdable object is at the first position, and FIG. 36 shows a case in which the holdable object is at the second position. Referring to FIGS. 35 and 36, the robot arm system includes a control apparatus 1D and a plurality of image capturing apparatuses 7-1 and 7-2, instead of the control apparatus 1 and the image capturing apparatus 7 of FIG. 1.

The image capturing apparatuses 7-1 and 7-2 are fixed to a ceiling, a floor, a wall, or the like, by supports 9-1 and 9-2, so as to capture different portions of the circuit board 8, respectively.

The control apparatus 1D selectively obtains a captured image obtained by one of the plurality of image capturing apparatuses 7-1 and 7-2, the captured image including at least a part of the circuit board 8 and the tip 5a of a power driver 5.

In the case of FIG. 35, the image capturing apparatus 7-2 cannot capture the marker 6, and thus, the control apparatus 1D obtains the captured image of the image capturing apparatus 7-1. On the other hand, in the case of FIG. 36, since the image capturing apparatus 7-2 can capture the power driver 5, the marker 6, and the circuit board 8 from a position closer than that of the image capturing apparatus 7-1, the control apparatus 1D obtains the captured image of the image capturing apparatus 7-2. The control apparatus 1D can selectively obtain the captured image from the plurality of image capturing apparatuses 7-1 and 7-2 according to the capturing conditions, and the degree of freedom of capturing is improved as compared with the case of using only one image capturing apparatus.

### Advantageous Effect and Others of Fifth Embodiment

According to the fifth embodiment, the control apparatus 1D selectively obtains a captured image from a plurality of image capturing apparatuses 7-1 and 7-2, the captured image including the at least part of the work object and the tip of the holdable object.

With such a configuration, the control apparatus 1D can selectively obtain the captured image from the plurality of image capturing apparatuses 7-1 and 7-2 according to the capturing conditions, and the degree of freedom of capturing is improved as compared with the case of using only one image capturing apparatus.

### Sixth Embodiment

Next, a robot arm system according to a sixth embodiment is described. In the sixth embodiment, we will describe a case in which work on a work object is directly performed by a robot arm apparatus without using a holdable object, and a tip of the robot arm apparatus contacts with the work object, and has a known position in the camera coordinate system.

### Configuration of Sixth Embodiment Overall Configuration

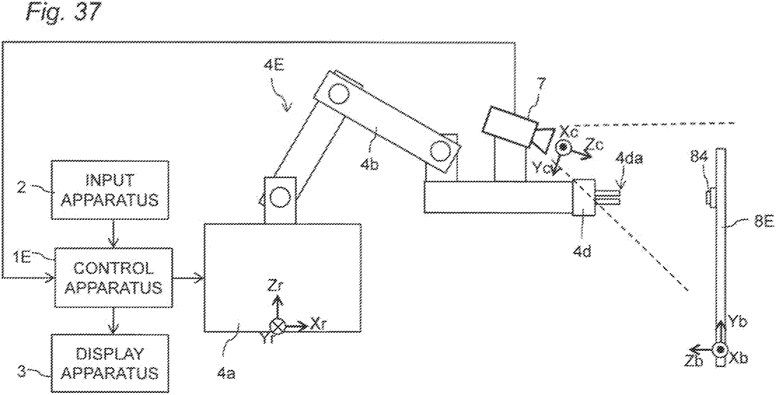

FIG. 37 is a schematic view showing a configuration of a robot arm system according to the sixth embodiment. The robot arm system of FIG. 37 is provided with a control apparatus 1E, a robot arm apparatus 4E, and a panel 8E, instead of the control apparatus 1, the robot arm apparatus 4, and the circuit board 8 of FIG. 1.

The control apparatus 1E controls the robot arm apparatus 4E, based on the captured image obtained by the image capturing apparatus 7, and/or based on user inputs inputted through the input apparatus 2.

The panel 8E is, for example, a control panel provided with one or a plurality of switches 84. The switch 84 includes, for example, a push switch, a toggle switch, a rotary switch, and the like.

The robot arm apparatus 4E is provided with an end effector 4d, instead of the hand 4c of the robot arm apparatus 4 of FIG. 1. The end effector 4d is configured to contact with the switch 84 at a tip 4da thereof, and to be capable of being manipulated by pressing, holding, rotating, and the like according to the form of the switch 84.

The image capturing apparatus 7 obtains the captured image including the tip 4da of the end effector 4d, and at least a part of the panel 8E.

The image capturing apparatus 7 is fixed at a known position with respect to the tip 4da of the end effector 4d. In this case, the image capturing apparatus 7 is fixed to the same link as that to which the end effector 4d is connected, among a plurality of links of an arm 4b. As a result, there is no movable part, such as a joint of the arm 4b, between the image capturing apparatus 7 and the end effector 4d, and therefore, the relative position of the image capturing apparatus 7 with respect to the tip 4da of the end effector 4d is fixed. Thus, the tip 4da of the end effector 4d has a known position in the camera coordinate system.

The robot arm apparatus 4E moves the tip of the robot arm apparatus 4E to the position of at least one target object in the work object, under the control of the control apparatus 1E. In the example of FIG. 37, the panel 8E is a work object to be directly worked by the robot arm apparatus 4E. When at least one switch 84 in the panel 8E is set as a target object, the robot arm apparatus 4E moves the tip 4da of the end effector 4d to the position of the switch 84, and operates the switch 84 using the end effector 4d.

In the present specification, the tip 4da of the end effector 4d is regarded as a tip of the robot arm apparatus 4E (also referred to as an “arm tip”).

### Configuration of Control Apparatus

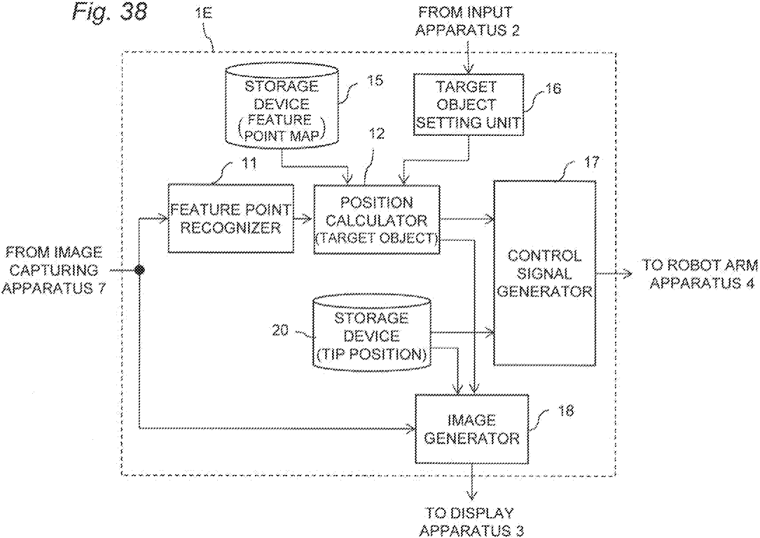

FIG. 38 is a block diagram showing a configuration of the control apparatus 1E of FIG. 37. The control apparatus 1E includes a storage device 20, instead of the marker recognizer 13 and the position calculator 14 of FIG. 5.

The storage device 20 stores in advance the position and the direction of the tip 4da of the end effector 4d in the camera coordinate system. This position is calculated based on, for example, design data of the robot arm apparatus 4E.

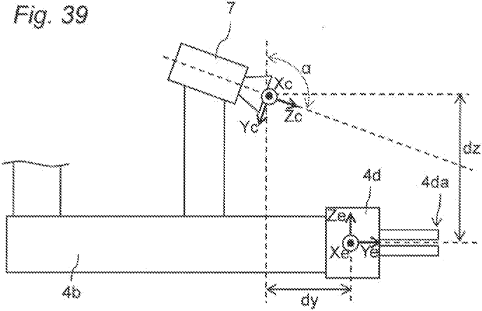

FIG. 39 is an enlarged view showing the tip of the arm 4b of FIG. 37. Referring to FIG. 39, calculation of the position and the direction of the tip 4da of the end effector 4d in the camera coordinate system is described.

In order to describe the position and the direction of the tip 4da of the end effector 4d in the camera coordinate system, the coordinate system of the end effector 4d is referred to as shown in FIG. 39. The end effector 4d has a three-dimensional coordinate system based on the position and the posture of the end effector 4d. The coordinate system of the end effector 4d has coordinate axes Xe, Ye, and Ze. For example, the origin of the coordinate system of the end effector 4d is provided inside a housing of the end effector 4d, and the direction of the coordinate system of the end effector 4d is set such that one of the coordinate axes passes through the tip 4da of the end effector 4d.

The coordinate transformation from the position (xe, ye, ze) in the coordinate system of the end effector 4d to the position (xc, yc, zc) in the camera coordinate system is expressed as follows, for example, using a homogeneous coordinate transformation matrix.

$$\left(\begin{matrix}x c \\ y c \\ z c \\ 1\end{matrix}\right) = {\left(\begin{matrix}{R}_{e c} & {t}_{e c} \\ 0 & 1\end{matrix}\right)}^{- 1} \left(\begin{matrix}x e \\ y e \\ z e \\ 1\end{matrix}\right)$$

Here, R_{ec} denotes a matrix indicating the direction of the camera coordinate system with reference to on the direction of the coordinate system of the end effector 4d, and tₑᵣ denotes a vector indicating the position (dx, dy, dz) of the origin of the camera coordinate system in the coordinate system of the end effector 4d. The matrix R_{ec} can be represented by, for example, matrices R_{α}, R_{β}, and R_{γ} representing rotation angles α, β, and γ around the X axis, the Y axis, and the Z axis, respectively.

The position and the direction of the tip 4da of the end effector 4d in the coordinate system of the end effector 4d are known from the design data of the robot arm apparatus 4E. Therefore, the position and the direction of the tip 4da of the end effector 4d in the camera coordinate system can be calculated using Mathematical Expression (6), based on the position and the direction of the tip 4da of the end effector 4d in the coordinate system of the end effector 4d.

Even when the end effector 4d is provided with movable parts, a trajectory of the tip 4da in the coordinate system of the end effector 4d is known, and therefore, the tip 4da has the known position and the known direction in the camera coordinate system.

The feature point recognizer 11, the position calculator 12, the storage device 15, and the target object setting unit 16 of FIG. 38 are configured and operate in a manner substantially similar to that of the corresponding components of FIG. 5. However, the components 11, 12, 15, and 16 of FIG. 38 calculate the position and the direction of the switch 84 of the panel 8E, instead of the position and the direction of the screw hole 82 of the circuit board 8.

A control signal generator 17 converts the position and the direction of the switch 84 in the camera coordinate system calculated by the position calculator 12, into the position and the direction in the robot coordinate system. In addition, the control signal generator 17 converts the position and the direction of the tip 4da of the end effector 4d in the camera coordinate system read from the storage device 20, into the direction and the position in the robot coordinate system. In addition, the control signal generator 17 outputs a control signal to the robot arm apparatus 4 based on the converted position and direction of the switch 84 and the converted position and direction of the tip 4da of the end effector 4d, the control signal causing the tip 4da of the end effector 4d to move to the position of the switch 84. Thus, the control apparatus 1E automatically controls the robot arm apparatus 4E.

The image generator 18 outputs the captured image to the display apparatus 3. In addition, the image generator 18 may output the feature points of the panel 8E, the position of the switch 84, and the position of the tip 4da of the end effector 4d to the display apparatus 3, such that the feature points of the panel 8E, the position of the switch 84, and the position of the tip 4da of the end effector 4d overlap the captured image.

Although FIG. 38 shows a case where the control apparatus 1E is provided with the two storage devices 15 and 20, these storage devices may be integrated with each other.

### Operation of Sixth Embodiment

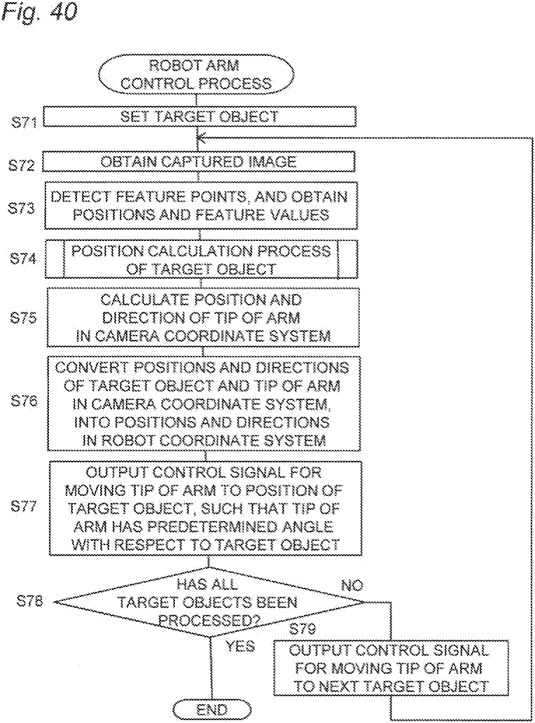

FIG. 40 is a flowchart showing a robot arm control process executed by the control apparatus 1E of FIG. 37.

The target object setting unit 16 sets at least one switch 84 in the panel 8E as the target object (step S71).

The control apparatus 1 obtains the captured image from the image capturing apparatus 7 (step S72).

The feature point recognizer 11 detects the feature points of the panel 8E from the captured image, and obtains positions and feature values of the feature points (step S73).

The position calculator 12 executes a position calculation process of target object to calculate the position and the direction of the switch 84 in the camera coordinate system (step S74).

Step 74 is substantially similar to step S4 of FIG. 9, except for calculating the position and the direction of the switch 84 of the panel 8E, instead the position and the direction of the screw hole 82 of the circuit board 8.

The control signal generator 17 reads the position and the direction of the tip 4da of the end effector 4d in the camera coordinate system, from the storage device 20 (step S75).

The control signal generator 17 converts the positions and the directions of the switch 84 and the tip 4da of the end effector 4d in the camera coordinate system, into the positions and the directions in the robot coordinate system (step S76).

The control signal generator 17 outputs a control signal causing the tip 4da of the end effector 4d to move to the position of the switch 84, such that the tip 4da of the end effector 4d has a predetermined angle with respect to the switch 84 (for example, the switch 84 as a push switch is pressed by the end effector 4d in the vertical direction) (step S77).

The control apparatus 1 may repeat steps S72 to S77 while moving the tip 4da of the end effector 4d to the position of the switch 84.

When the plurality of switches 84 in the panel 8E are set as the target objects, the control signal generator 17 determines whether or not all the target objects have been processed (step S78): if YES, the process ends; if NO, the process proceeds to step S79.

The control signal generator 17 outputs a control signal causing the tip 4da of the end effector 4d to move to the next switch 84 (step S79). Thereafter, the control apparatus 1 repeats steps S72 to S79.

According to the sixth embodiment, even when the panel 8E does not have a fixed known position in the robot coordinate system, it is possible to control the robot arm apparatus 4 to accurately perform work on the panel 8E, by calculating the position and the direction in the robot coordinate system based on the captured image. According to the sixth embodiment, even when the panel 8E moves, it is possible to control the robot arm apparatus 4 to follow the change in the position and the direction thereof, and accurately perform the work on the panel 8E.

### ADVANTAGEOUS EFFECT AND OTHERS OF SIXTH EMBODIMENT

According to the sixth embodiment, a control apparatus 1E for controlling a robot arm apparatus 4E is provided with: a target object setting unit 16, a feature point recognizer 11, a position calculator 12, and a control signal generator 17. The target object setting unit 16 sets a position of at least one target object in a work object. The feature point recognizer 11 detects feature points of the work object from a captured image obtained by an image capturing apparatus 7, the captured image including at least a part of the work object, the image capturing apparatus 7 being fixed at a known position with respect to a tip of the robot arm apparatus 4E. The position calculator 12 calculates a position of the target object in a coordinate system of the image capturing apparatus 7 based on the feature points of the work object. The control signal generator 17 converts the position of the target object and a position of the tip of the robot arm apparatus 4E in the coordinate system of the image capturing apparatus 7, into positions in a coordinate system of the robot arm apparatus 4E, and outputs a control signal to the robot arm apparatus 4E based on the converted position of the target object and the converted position of the tip of the robot arm apparatus 4E, the control signal causing the tip of the robot arm apparatus 4E to move to the position of the target object.

With such a configuration, even when the work object does not have a known fixed position in the robot coordinate system, it is possible to control the robot arm apparatus 4 to accurately perform the work on the work object. For example, even when “a deviation of work object” occurs, in which a part of the robot arm apparatus 4E strikes the work object during the work, and the work object deviates from a workbench fixed to the robot coordinate system, it is possible to accurately perform the work. In addition, even when “mismatch of control” occurs, in which predicted coordinates of the tip of the robot arm apparatus 4 deviate from actual coordinates through repetition of the work, it is possible to accurately perform the work.

### Seventh Embodiment

Next, a robot arm system according to a seventh embodiment is described. In the first to sixth embodiments, the case where the control apparatus automatically controls the robot arm apparatus has been described. On the other hand, in the seventh embodiment, we will describe a case of aiding the user’s manual control of the robot arm apparatus.

### Configuration of Seventh Embodiment

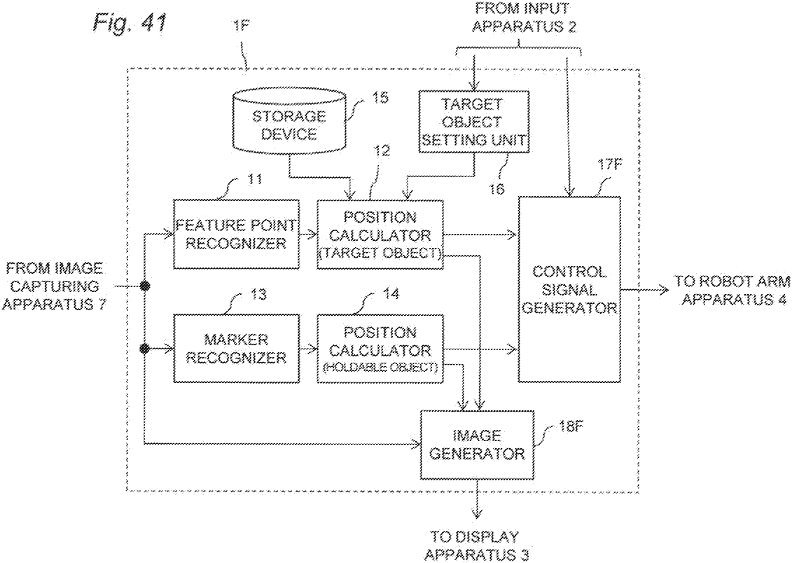

FIG. 41 is a block diagram showing a configuration of a control apparatus 1F of a robot arm system according to the seventh embodiment. The control apparatus 1F is used, for example, instead of the control apparatus 1 of the robot arm system of FIG. 1. The control apparatus 1F is provided with a control signal generator 17F and an image generator 18F, instead of the control signal generator 17 and the image generator 18 of FIG. 5.

The control signal generator 17F outputs a first control signal to a robot arm apparatus 4 based on the captured image obtained by the image capturing apparatus 7, the first control signal causing the tip of the holdable object to move to the position of the target object, as described in the first embodiment and others. Further, the control signal generator 17F outputs a second control signal to the robot arm apparatus based on the user inputs obtained through the input apparatus 2, the second control signal also causing the tip of the holdable object to move to the position of the target object.

The image generator 18F generates a radar chart representing the distance of the tip of the holdable object from the target object, and outputs the radar chart to the display apparatus 3 such that the radar chart overlaps the captured image.

By referring to the radar chart displayed on the display apparatus 3, the user can provide the user inputs to the control apparatus 1F through the input apparatus 2, the user inputs causing the tip of the holdable object to move to the position of the target object.

### Operation of Seventh Embodiment

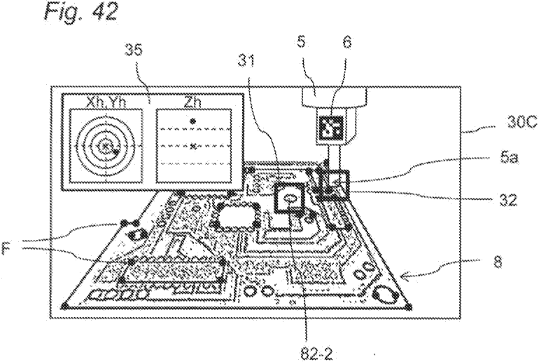

FIG. 42 is a diagram showing an exemplary image 30C displayed on the display apparatus 3 of the robot arm system according to the seventh embodiment. The image 30C includes a window 35, as well as the contents of the image 30 of FIG. 15.

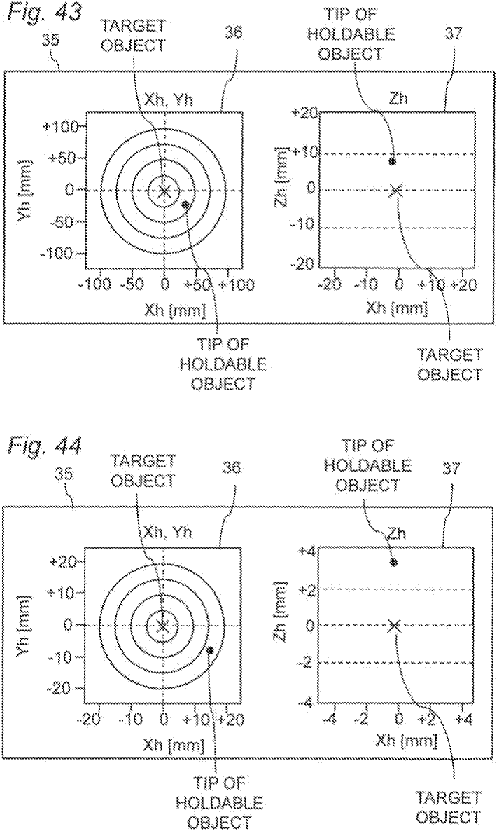

FIG. 43 is a diagram showing details of the window 35 of FIG. 42, including radar charts 36 and 37 in which the tip of the holdable object is at a first distance from the target object. FIG. 44 is a diagram showing details of the window 35 of FIG. 42, including the radar charts 36 and 37 in which the tip of the holdable object is at a second distance shorter than the first distance from the target object. The window 35 includes the radar chart 36 in a horizontal plane and the radar chart 37 in a vertical plane. The radar chart 36 represents the distance of the tip of the holdable object from the target object in the horizontal plane. The radar chart 37 represents the distance of the tip of the holdable object from the target object in the vertical plane. In the examples of FIGS. 43 and 44, the radar charts 36 and 37 have coordinate axes Xh, Yh, and Zh of the target object coordinate system. As shown in FIGS. 43 and 44, the scale of the radar chart may be changed according to the distance of the tip of the holdable object from the target object. By reducing the width of the scale of the radar chart when the tip of the holdable object approaches the target object, and increasing the width of the scale of the radar chart when the tip of the holdable object moves away from the target object, it is possible to more clearly recognize the distance of the tip of the holdable object from the target object.

The radius of the smallest circle in the radar chart 36 in the horizontal plane may be set to, for example, 0.25, 1, 5, 25, or 100 mm. The vertical scale in the radar chart 37 in the vertical plane may be set to, for example, 2 or 10 mm.

By displaying the window 35, it is possible to more clearly present to the user the distance of the tip of the holdable object from the target object, than the case of displaying only the captured image including the target object and the holdable object. By calculating a small deviation of the tip of the holdable object from the target object and displaying the deviation as a radar chart, the user can reliably determine whether or not the tip of the holdable object has reached the target object.

The user may monitor the work of the robot arm apparatus 4, by watching the window 35. In addition, the user may operate the robot arm apparatus 4 through the input apparatus 2, while watching the window 35. The control apparatus 1 executes the robot arm control process of FIG. 9. In this case, the control apparatus 1 repeats steps S2 to S8 while moving the tip of the holdable object to the position of the target object, as described above. If there is no user input, the control signal generator 17F outputs a control signal generated based on the captured image obtained by the image capturing apparatus 7. On the other hand, when obtaining the user inputs through the input apparatus 2, the control signal generator 17F interrupts the robot arm control process, and outputs a control signal generated based on the user inputs.

According to the seventh embodiment, even when the holdable object and the target object do not have known fixed positions in the robot coordinate system, it is possible to control the robot arm apparatus 4 to accurately perform the work on the work object using the holdable object, by watching the window 35 and operating the robot arm apparatus 4 through the input apparatus 2.

For example, when performing remote control of the robot arm apparatus 4, a two-dimensional captured image can be obtained from a remote place, but three-dimensional information is required to align the work object with the holdable object. However, three-dimensional information may not be read from the two-dimensional captured image. In the example of FIG. 6, the lateral deviation of the holdable object and the work object can be read from the two-dimensional captured image, but the longitudinal (depth) deviation and the vertical deviation of the holdable object and the work object are apparently combined in the longitudinal direction on the two-dimensional captured image, and therefore, it is difficult to read the latter two deviations from the captured image. In this case, by using the radar chart or the like to visualize the deviation along each three-dimensional coordinate axis as a certain physical quantity (for example, a deviation of several millimeters), it is possible to read three-dimensional information, and also remotely control the robot arm apparatus 4.

Furthermore, by using the radar chart or the like to present the deviation as a certain physical quantity, it is not necessary to empirically obtain the three-dimensional deviation from the deviation of the captured image. Therefore, for example, even an unskilled person can easily control the robot arm apparatus 4 by simply pressing a control button of the input apparatus 2 according to the physical quantity.

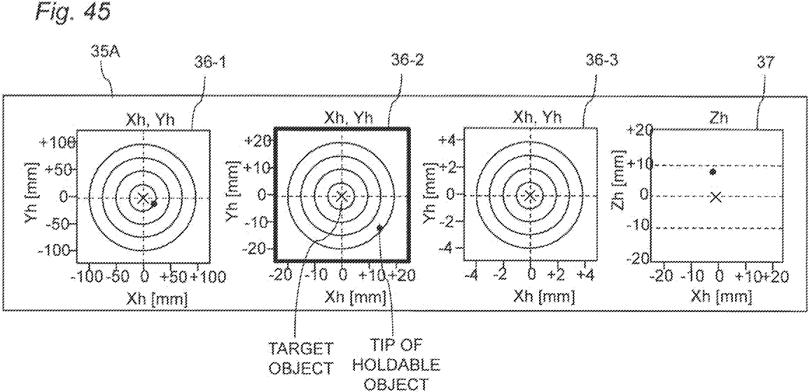

FIG. 45 is a diagram showing an alternative window 35A displayed on the display apparatus 3 of the robot arm system according to the seventh embodiment. The image 30C displayed on the display apparatus 3 may include the window 35A of FIG. 45, instead of the window 35 of FIG. 42. A plurality of radar charts 36 having different scales in horizontal planes may be simultaneously displayed in the window 35A. Similarly, a plurality of radar charts 37 having different scales in vertical planes may be simultaneously displayed in the window 35A. The example of FIG. 45 shows a case where three radar charts 36-1 to 36-3 in horizontal planes are simultaneously displayed in the window 35A, and one radar chart 37 in vertical plane is displayed in the window 35A. Among the plurality of radar charts 36, one having the most appropriate scale for observing the distance of the tip of the holdable object from the target object, that is, one in which the tip of the holdable object is the most remote from the target object in a display area of the radar chart, may be highlighted (for example, surrounding with a frame, changing a color, or the like). The example of FIG. 45 shows a case where the frame of the radar chart 36-2 in the horizontal plane is highlighted. By displaying the plurality of radar charts 36-1 to 36-3, it is possible to more clearly present to the user the distance of the tip of the holdable object from the target object, than displaying only one radar chart 36.

### Modified Embodiment of Seventh Embodiment

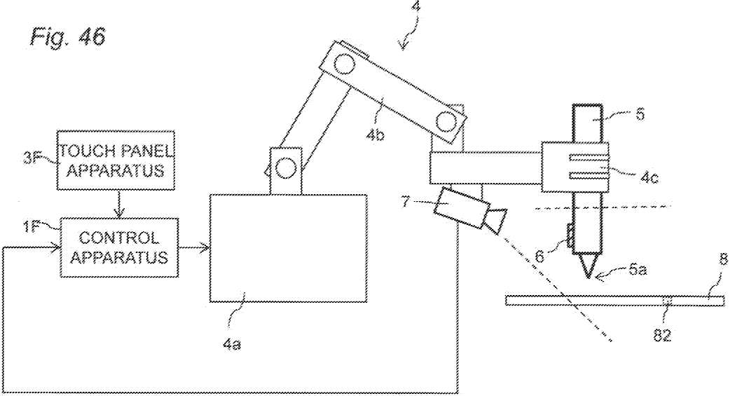

FIG. 46 is a schematic view showing a configuration of a robot arm system according to a first modified embodiment of the seventh embodiment. The robot arm system of FIG. 46 is provided with a control apparatus 1F and a touch panel apparatus 3F, instead of the control apparatus 1, the input apparatus 2, and the display apparatus 3 of FIG. 1.

The control apparatus 1F of FIG. 46 is configured and operates in a manner similar to that of the control apparatus 1F of FIG. 41. However, the control apparatus 1F of FIG. 46 obtains the user inputs from the touch panel apparatus 3F, instead of the input apparatus 2, and displays an image on the touch panel apparatus 3F, instead of the display apparatus 3. In addition, the image generator 18F of the control apparatus 1F of FIG. 46 further outputs an image of operating buttons for obtaining the user inputs, to the touch panel apparatus 3F, such that the image of operating buttons overlaps the captured image.

The touch panel apparatus 3F has the functions of both the control apparatus 1 and the input apparatus 2 of FIG. 1.

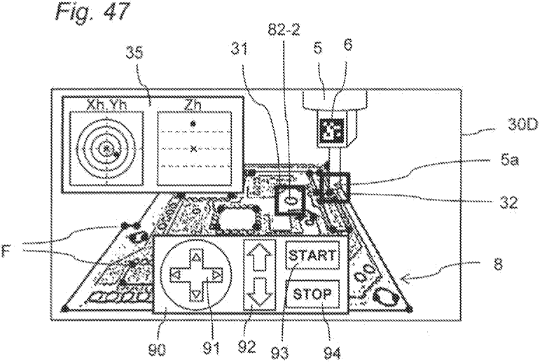

FIG. 47 is a diagram showing an exemplary image 30D displayed on the touch panel apparatus 3F of the robot arm system of FIG. 46. The image 30D includes a window 90, as well as the contents of the image 30C of FIG. 42. The window 90 includes, for example, a plurality of operating buttons 91 to 94. The operating button 91 instructs horizontal movements of the power driver 5. The operating button 92 instructs vertical movement of the power driver 5. The operating button 93 instructs the power driver 5 to start screw tightening. The operating button 94 instructs the power driver 5 to stop the screw tightening.

By displaying the window 90, even when the robot arm system includes the touch panel apparatus 3F, it is possible to provide the control apparatus 1F with the user inputs for moving the tip of the holdable object to the position of the target object.

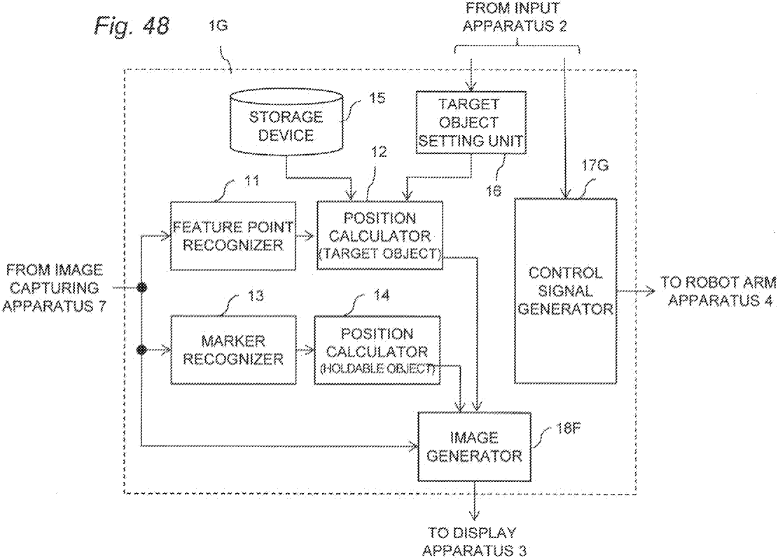

FIG. 48 is a block diagram showing a configuration of a control apparatus 1G of a robot arm system according to a second modified embodiment of the seventh embodiment. The control apparatus 1G includes a control signal generator 17G, instead of the control signal generator 17F of FIG. 41. The control signal generator 17G outputs a control signal to the robot arm apparatus 4 based on the user inputs obtained through the input apparatus 2, the control signal causing the tip of the holdable object to move to the position of the target object. In other words, the control signal generator 17G generates the control signal based on only the user inputs obtained through the input apparatus 2, without generating the control signal based on the captured image obtained by the image capturing apparatus 7. According to the control apparatus 1G of FIG. 48, even when the holdable object and the target object do not have known fixed positions in the robot coordinate system, it is possible to control the robot arm apparatus 4 to accurately perform the work on the work object using the holdable object, by watching the window 35 and operating the robot arm apparatus 4 through the input apparatus 2.

### Advantageous Effect and Others of Seventh Embodiment

According to the seventh embodiment, a control apparatus 1F may be further provided with an image generator 18F that generates a radar chart representing a distance of the tip of the holdable object from the target object, and outputs the radar chart and the captured image to a display apparatus 3 such that the radar chart overlaps the captured image. The control signal generator 17F outputs a second control signal to the robot arm apparatus 4 based on a second user input obtained through an input apparatus 2, the second control signal causing the tip of the holdable object to move to the position of the target object.

With such a configuration, it is possible to more clearly present to the user the distance of the tip of the holdable object from the target object, than the case of displaying only the captured image including the target object and the holdable object to the display apparatus 3. In addition, it is possible to control the robot arm apparatus 4 to accurately perform the work on the work object using the holdable object, by watching the radar chart and operating the robot arm apparatus 4 through the input apparatus 2.

According to the seventh embodiment, the image generator 18F may generate a radar chart having a variable scale according to the distance of the tip of the holdable object from the target object.

With such a configuration, it is possible to more clearly present to the user the distance of the tip of the holdable object from the target object, than the case of generating a radar chart having a fixed scale.

According to the seventh embodiment, the image generator 18F may output an image of an operating button and the captured image such that the image of the operating button overlaps the captured image, the operating button being provided to obtain the second user input.

With such a configuration, even when the robot arm system includes the touch panel apparatus 3F, it is possible to provide the control apparatus 1F with the user inputs for moving the tip of the holdable object to the position of the target object.

According to the seventh embodiment, a control apparatus 1 for controlling a robot arm apparatus 4 holding a holdable object is provided with: a target object setting unit 16, a feature point recognizer 11, a first position calculator 12, a second position calculator 14, an image generator 18F, and a control signal generator 17G. The target object setting unit 16 sets a position of at least one target object in a work object. The feature point recognizer 11 detects feature points of the work object from a captured image obtained by at least one image capturing apparatus, the captured image including at least a part of the work object and a tip of the holdable object. The first position calculator 12 calculates a position of the target object in a coordinate system of the image capturing apparatus based on the feature points of the work object. The second position calculator 14 calculates a position of the tip of the holdable object in the coordinate system of the image capturing apparatus based on the captured image. The image generator 18F generates a radar chart representing a distance of the tip of the holdable object from the target object, and outputs the radar chart and the captured image to a display apparatus 3 such that the radar chart overlaps the captured image. The control signal generator 17G outputs a control signal to the robot arm apparatus 4 based on a user input obtained through an input apparatus, the control signal causing the tip of the holdable object to move to the position of the target object.

With such a configuration, it is possible to more clearly present to the user the distance of the tip of the holdable object from the target object, than the case of displaying only the captured image including the target object and the holdable object to the display apparatus 3. In addition, it is possible to control the robot arm apparatus 4 to accurately perform the work on the work object using the holdable object, by watching the radar chart and operating the robot arm apparatus 4 through the input apparatus 2.

### Other Embodiments

The input apparatus and the display apparatus may be integrated with the control apparatus. The control apparatus, the input apparatus, and the display apparatus may be integrated with the robot arm apparatus.

The image generator may output a three-dimensional plot of the feature point map as shown in FIG. 12 to the display apparatus, such that the three-dimensional plot overlaps the captured image.

In the examples of the first to fourth embodiments, the holdable object is the power driver 5, and the target object in the work object is the screw hole in the circuit board. However, the holdable object, the work object, and the target object are not limited thereto. The holdable object may be, for example, a soldering iron, a multimeter, a test tube, a pipette, a cotton swab, or the like. In the case where the holdable object is the soldering iron, the work object may be a circuit board, and the target object may be a circuit board or an electrode of an electronic component. In the case where the holdable object is a probe of the multimeter, the work object may be an electronic device, and the target object may be an electrode. In the case where the holdable object is the test tube, the work object may be a rack for test tubes, and the target object may be a hole in the rack for test tubes. In the case where the holdable object is the pipette, the work object may be a container into which a medicine or the like is put in or taken out by the pipette, and the target object may be an opening of the container. In the case where the holdable object is the cotton swab, the work object may be a patient in contact with the cotton swab, and the target object may be a site of the patient in contact with the cotton swab. Also in these cases, even when at least one of the holdable object and the work object does not have a known fixed position in the robot coordinate system, it is possible to control the robot arm apparatus to accurately perform the work on the work object using the holdable object.

In the above description, the case where the holdable object is held such that the direction of the holdable object (power driver 5) matches the direction of the target object (screw hole 82) has been described. However, the holdable object may be held such that the holdable object has other predetermined angles with respect to the target object. For example, in the case where the holdable object is the soldering iron or the multimeter, the holdable object may be held obliquely with respect to the circuit board or the electrode.

When the work object is flat, and the holdable object moves translationally with respect to the work object without changing the direction, the step of calculating the directions of the work object and the holdable object may be omitted.

In the present specification, the “tip of the holdable object” is not limited to a sharp portion like the tip 5a of the power driver 5, but the term means a distal end of the holdable object as seen from the main body of the robot arm apparatus 4. The tip of the holdable object may be a hammer head, a bottom surface of a container such as a beaker, a bottom surface of a rectangular member, or the like, depending on the shape of the holdable object.

In the example of the sixth embodiment, the case where the target object in the work object is the switch of the panel has been described, but the work object and the target object are not limited thereto. For example, the work object may be a circuit board, and the target object may be a screw hole or an electrode. In addition, the work object may be a container, and the target object may be an opening of the container. In addition, the work object may be a patient, and the target object may be a site of the patient. According to the types of the work object and the target object, the robot arm apparatus is provided with a device (such as a power driver) integrated with the tip of the arm.

The above-described embodiments and modified embodiments may be combined.

If the robot arm apparatus can hold the holdable object such that the image capturing apparatus has a known position with respect to the tip of the robot arm apparatus, the control apparatus according to the sixth embodiment may control a robot arm apparatus provided with a hand that holds the holdable object. The robot arm apparatus may hold the holdable object such that the image capturing apparatus has a known position with respect to the tip of the robot arm apparatus, for example, by providing the hand with a guide to be engaged with the holdable object. In this case, the control apparatus reads the position and the direction of the holdable object stored in the storage device in advance, instead of calculating the position and the direction of the holdable object based on the captured image.

The seventh embodiment is applicable to any of the first to sixth embodiments. Each of the image generator 18 of FIG. 17, the image generator 18B of FIG. 23, and the image generator 18 of FIG. 29 may output, to the display apparatus 3, the radar chart representing the distance of the tip of the holdable object from the target object, such that the radar chart overlaps the captured image. In this case, each of the control signal generator 17 of FIG. 17, the control signal generator 17B of FIG. 23, and the control signal generator 17 of FIG. 29 outputs a control signal to the robot arm apparatus 4 based on the user inputs obtained through the input apparatus 2, the control signal causing the tip of the holdable object to move to the position of the target object. In addition, the image generator 18 of FIG. 38 may output, to the display apparatus 3, the radar chart representing the distance of the tip of the robot arm apparatus from the target object, such that the radar chart overlaps the captured image. In this case, the control signal generator 17 of FIG. 38 outputs a control signal to the robot arm apparatus 4 based on the user inputs obtained through the input apparatus 2, the control signal causing the tip of the robot arm apparatus to move to the position of the target object.

The control apparatus and the robot arm system according to each aspect of the present disclosure can be applied to an industrial or medical robot arm apparatus.

1. A control apparatus for controlling a robot arm apparatus that holds a holdable object, the control apparatus comprising:
a camera that that captures an image including at least a part of a work object and a tip of the holdable object; and
a processing circuit that controls the robot arm apparatus that holds the holdable object,
wherein the processing circuit sets a position of a target object included in the work object;
wherein the processing circuit detects feature points of the work object from the captured image;
wherein the processing circuit calculates a position of the target object based on the feature points of the work object;
wherein the processing circuit calculates a position of the tip of the holdable object based on the captured image; and
wherein the processing circuit outputs a first control signal to the robot arm apparatus based on the position of the target object and the position of the tip of the holdable object, the first control signal causing the tip of the holdable object to move to the position of the target object.

2. The control apparatus as claimed in claim 1,
wherein the processing circuit calculates a position of the target object in a coordinate system of the camera based on the feature points of the work object;
wherein the processing circuit a first position calculator that calculates a position of the tip of the holdable object in the coordinate system of the camera based on the captured image; and
wherein the processing circuit a first position calculator that converts the position of the target object and the position of the tip of the holdable object in the coordinate system of the camera, into positions in a coordinate system of the robot arm apparatus.

3. The control apparatus as claimed in claim 2,
wherein the processing circuit further calculates a direction of the target object in the coordinate system of the camera based on the feature points of the work object,
wherein the processing circuit further calculates a direction of the holdable object in the coordinate system of the camera based on the captured image, and
wherein the processing circuit converts the direction of the target object and the direction of the holdable object in the coordinate system of the camera, into directions in the coordinate system of the robot arm apparatus, and the first control signal further includes angle information based on the converted direction of the target object and the converted direction of the holdable object.

4. The control apparatus as claimed in claim 2,
wherein the processing circuit detects a first marker from the captured image, the first marker being fixed at a predetermined position of the holdable object, the first marker having a pattern formed such that a position of the first marker in the coordinate system of the camera can be calculated,
wherein the processing circuit calculates the position of the tip of the holdable object based on the first marker.

5. The control apparatus as claimed in claim 1,
wherein the camera further obtains distances from the camera to points captured by the camera,
wherein the processing circuit further detects feature points of the holdable object from the captured image, and
wherein the processing circuit calculates the position of the tip of the holdable object based on the feature points of the holdable object and the distances.

6. The control apparatus as claimed in claim 1, further comprising a memory that stores a feature point map in advance, the feature point map including three-dimensional coordinates of a plurality of feature points included in the work object, and two-dimensional coordinates of the plurality of feature points in a plurality of captured images obtained by capturing the work object from a plurality of different positions,
wherein the processing circuit calculates the position of the target object with reference to the feature point map.

7. The control apparatus as claimed in claim 1,
wherein the camera further obtains distances from the camera to points captured by the camera, and
wherein the processing circuit:
generates a feature point map based on the captured image and the distances, the feature point map including three-dimensional coordinates of a plurality of feature points included in the work object, and two-dimensional coordinates of the plurality of feature points in a plurality of captured images obtained by capturing the work object from a plurality of different positions, and
calculates the position of the target object with reference to the feature point map.

8. The control apparatus as claimed in claim 2,
wherein the processing circuit detects a second marker from the captured image, the second marker being fixed at a predetermined position of the work object, the second marker having a pattern formed such that a position of the second marker in the coordinate system of the camera can be calculated,
wherein the processing circuit:
calculates a distance from the camera to the work object based on the second marker,
generates a feature point map based on the captured image and the distance, the feature point map including three-dimensional coordinates of a plurality of feature points included in the work object, and two-dimensional coordinates of the plurality of feature points in a plurality of captured images obtained by capturing the work object from a plurality of different positions, and
calculates the position of the target object with reference to the feature point map.

9. The control apparatus as claimed in claim 7, further comprising a memory that stores the feature point map generated by the processing circuit.

10. The control apparatus as claimed in claim 7,
wherein the processing circuit recognizes and sets the position of the target object in the work object using image processing.

11. The control apparatus as claimed in claim 7,
wherein the processing circuit sets the position of the target object in the work object based on a first user input obtained through a first input apparatus.

12. The control apparatus as claimed in claim 1,
wherein the camera is fixed to the robot arm apparatus such that the camera can capture the tip of the holdable object when the robot arm apparatus holds the holdable object.

13. The control apparatus as claimed in claim 1,
wherein the control apparatus selectively obtains a captured image from a plurality of cameras, the captured image including the at least part of the work object and the tip of the holdable object.

14. The control apparatus as claimed in claim 1,
wherein the processing circui generates a radar chart representing a distance of the tip of the holdable object from the target object, and outputs the radar chart and the captured image to a display apparatus such that the radar chart overlaps the captured image,
wherein the processing circuit outputs a second control signal to the robot arm apparatus based on a second user input obtained through a second input apparatus, the second control signal causing the tip of the holdable object to move to the position of the target object.

15. The control apparatus as claimed in claim 14,
wherein the processing circuit generates a radar chart having a variable scale according to the distance of the tip of the holdable object from the target object.

16. The control apparatus as claimed in claim 14,
wherein the processing circuit outputs an image of an operating button and the captured image such that the image of the operating button overlaps the captured image, the operating button being provided to obtain the second user input.

17. A control apparatus for controlling a robot arm apparatus that holds a holdable object, the control apparatus comprising:
a camera that captures an image including at least a part of a work object and a tip of the holdable object; and
a processing circuit that controls the robot arm apparatus that holds the holdable object,
wherein the processing circuit sets a position of a target object included in the work object;
wherein the processing circuit detects feature points of the work object from the captured image;
wherein the processing circuit calculates a position of the target object based on the feature points of the work object;
wherein the processing circuit calculates a position of the tip of the holdable object based on the captured image;
wherein the processing circuit generates a radar chart representing a distance of the tip of the holdable object from the target object, and outputs the radar chart and the captured image to a display apparatus such that the radar chart overlaps the captured image; and
wherein the processing circuit that outputs a control signal to the robot arm apparatus based on a user input obtained through an input apparatus, the control signal causing the tip of the holdable object to move to the position of the target object.

18. A control apparatus for controlling a robot arm apparatus, the control apparatus comprising:
a camera being fixed at a predetermined position with respect to a tip of the robot arm apparatus, the camera captures an image including at least a part of a work object; and
a processing circuit that controls the robot arm apparatus,
wherein the processing circuit sets a position of a target object included in the work object;
wherein the processing circuit detects feature points of the work object from the captured image;
wherein the processing circuit calculates a position of the target object based on the feature points of the work object; and
wherein the processing circuit outputs a control signal to the robot arm apparatus based on the position of the target object and the position of the tip of the robot arm apparatus, the control signal causing the tip of the robot arm apparatus to move to the position of the target object.

19. The control apparatus as claimed in claim 18,
wherein the processing circuit calculates a position of the target object in a coordinate system of the camera based on the feature points of the work object; and
wherein the processing circuit a first position calculator that converts the position of the target object and the position of the tip of the robot arm apparatus in the coordinate system of the camera, into positions in a coordinate system of the robot arm apparatus.

20. A robot arm system comprising:
a robot arm apparatus that holds a holdable object;
at least one camera that captures an image including at least a part of a work object and a tip of the holdable object; and
a control apparatus comprises a processing circuit that controls the robot arm apparatus that holds the holdable object,
wherein the processing circuit sets a position of a target object included in the work object;
wherein the processing circuit detects feature points of the work object from the captured image;
wherein the processing circuit calculates a position of the target object based on the feature points of the work object;
wherein the processing circuit calculates a position of the tip of the holdable object based on the captured image; and
wherein the processing circuit outputs a first control signal to the robot arm apparatus based on the position of the target object and the position of the tip of the holdable object, the first control signal causing the tip of the holdable object to move to the position of the target object.

21. A control method for controlling a robot arm apparatus holding a holdable object, the control method including the steps of:
setting a position of a target object included in a work object;
detecting feature points of the work object from a captured image obtained by a camera, the captured image including at least a part of the work object and a tip of the holdable object;
calculating a position of the target object based on the feature points of the work object;
calculating a position of the tip of the holdable object based on the captured image; and
outputting a control signal to the robot arm apparatus based on the position of the target object and the position of the tip of the holdable object, the control signal causing the tip of the holdable object to move to the position of the target object.
